(19) United States
(12) Patent Application Publication
(10) Pub. No.: US 2014/0058559 A1
(43) Pub. Date: Feb. 27, 2014

(54) Systems, Devices, and/or Methods for Dispensing

(71) Applicant: Michael N. Haynes, Keswick, VA (US)

(72) Inventor: Michael N. Haynes, Keswick, VA (US)

(21) Appl. No.: 13/070,018

(22) Filed: Mar. 23, 2011

Related U.S. Application Data
(60) Provisional application No. 61/317,006, filed on Mar. 24, 2010.

(51) Int. Cl. G06F 17/00; A45B 3/00; A01K 29/00

(52) U.S. Cl. 700/232; 119/57.7; 135/66

(57) ABSTRACT

Certain exemplary embodiments can provide a system, machine, device, manufacture, circuit, composition of matter, and/or user interface adapted for and/or resulting from, and/or a method and/or machine-readable medium comprising machine-implementable instructions for, activities that can comprise and/or relate to, automatically, remotely, and/or non-manually delivering treats to an animal via a dispenser.

### CROSS-REFERENCES TO RELATED APPLICATIONS

This application claims priority to, and incorporates by reference herein in its entirety, pending U.S. Provisional Patent Application 61/317,006 (Attorney Docket 1007-024), filed 24 Mar. 2010.

### BRIEF DESCRIPTION OF THE DRAWINGS

A wide variety of potential embodiments will be more readily understood through the following detailed description of certain exemplary embodiments, with reference to the accompanying exemplary drawings in which:

FIG. 1 is a perspective view of an exemplary embodiment of an apparatus installed on a wheelchair;

FIG. 2 is a perspective view of an exemplary embodiment of an apparatus installed on a wheelchair;

FIG. 3 is a schematic view of an exemplary embodiment of an apparatus;

FIG. 4A is a side view of certain components of an exemplary embodiment of an apparatus;

FIG. 4B is a side view of certain components of an exemplary embodiment of an apparatus;

FIG. 5 is a schematic view of certain components an exemplary embodiment of an apparatus;

FIG. 6 is a section view of a first exemplary embodiment of an apparatus taken at section A-A of FIG. 5;

FIG. 7 is a section view of a second exemplary embodiment of an apparatus taken at section A-A of FIG. 5;

FIG. 8A is a side view of certain components of an exemplary embodiment of an apparatus;

FIG. 8B is a side view of certain components of an exemplary embodiment of an apparatus;

FIG. 9 is a block diagram of an exemplary embodiment of an information device;

FIG. 10A is a side view of certain components of an exemplary embodiment of an apparatus;

FIG. 10B is a side view of certain components of an exemplary embodiment of an apparatus; and

FIG. 11 is a perspective view of certain components of an exemplary embodiment of an apparatus.

### DETAILED DESCRIPTION

Humans have been domesticating animals, perhaps since pre-historical times. Today, domesticated animals generally can provide many services, including, for example, providing object retrieval, physical access, motive power, directional guidance, help beckoning, balance maintenance, hazard awareness, medical condition alerting, detection, protection, hunting, tracking, herding, socialization, companionship, entertainment, etc., any of which ultimately can tend to benefit one or more humans. Such animals potentially can include certain dogs, such as service dogs, guide dogs, assistance dogs, contraband detection dogs, tracking dogs, companion dogs, pet dogs, etc., and although less commonly, possibly can include certain other domesticated and/or trainable animals, such as animals generally recognized as cats, pigs, goats, sheep, horses, chimpanzees, dolphins, porpoises, falcons, pigeons, etc.

Desired behavior in many animals, whether domesticated or non-domesticated, can be encouraged and/or motivated by providing a reward, such as an edible treat, to the animal upon the animal's demonstration of the desired behavior. When a rather complex behavior is desired, the requester can break down the complex behavior into simpler behavioral elements, and can reward the animal for demonstrating any of those elements, until they are substantially learned and/or mastered. Then, multiple mastered elements can be requested in series until the series as a whole is substantially learned and/or mastered, and so forth, until the entire complex behavior is substantially learned and/or mastered. Similarly, to develop a desired behavior, the animal can be rewarded for demonstration of any behavior that to any selected degree approximates the desired behavior and/or one or more elements thereof.

In certain cases, a human is not able and/or does not desire to manually and/or directly dispense certain types of rewards to the animal. For example, a person who does not have adequate control over their hands might not be able to easily manually dispense a treat to a service dog (e.g., that is matched to that person) and thereby motivate and/or reward a trained and/or desired behavior from the service dog. As another example, a person walking a pet dog might not want to carry treats in their hand, pocket, and/or a treat pouch to manually dispense to the dog during the walk and/or might not want to contact the dog's mouth, tongue, and/or saliva. As still another example, a person riding in and/or driving a vehicle in which a domesticated animal is located and/or to which a service animal is attached (e.g., such as a horse-drawn wagon), might not desire and/or reasonably be able to dispense a reward to the animal to motivate, train, and/or reinforce a desired behavior. As yet another example, a person located remotely from an animal, such as a cat owner away at work while their cat is at home, a zookeeper safely located far outside of an animal's pen, and/or a wildlife manager located far away from a wild animal's feeding habitat, might be physically unable to directly and/or manually reward the animal.

For certain domesticated animals, a selected reward might be in the form of what is referred to herein as “kibble”, that is a foodstuff that can be animal-edible, relatively small (e.g., can have a largest dimension of from approximately 0.125 inches to approximately 2 inches (including all values and sub-ranges therebetween)), substantially dry, substantially hard, substantially brittle, processed, manufactured, coarsely ground, meal-based, cereal-based, and/or grain-based, etc. Other foodstuffs, such as those that are natural, fresh, raw, live, unprocessed, substantially oily, substantially wet, etc., might be selected. Other rewards, such as objects that roll, bounce, move, shimmy, rattle, squeak, crunch, shine, glitter, etc., might be selected.

Kibble and certain other rewards (collectively referred to herein as “treats”) can have physical properties that can make machine-based dispensing challenging. For example, certain treats can have somewhat irregular and/or coarsely-textured dimensions and/or outer surfaces that can tend to promote flow resistance, such as bridging, jamming, clogging, and/or poor conveyance of the treat within certain types of dispensing equipment. In these situations, attempting to overpower the treat sometimes can result in its fracture and/or damage (which can lead to further problems, such as further flow issues and/or lower reward value) and/or can result in mechanical and/or electrical damage to the dispensing equipment.

For example, experimental attempts to control the flow of dog kibble from a gravity-fed dispenser using a linear solenoid-actuated horizontally-oriented knife gate-style “valve” resulted in bridging and clogging immediately upstream of the valve and/or fracture of the kibble. Experimental attempts to dispense the same type of kibble from a gravity-fed dispenser via a rotating cup attached to a horizontally-oriented motor shaft and located within a housing resulted in jamming of the rotation and/or fracture of the kibble.

Although applicant does not intend to be bound by any particular theory, applicant currently theorizes that these and/or other failures might have been due to the substantially hard and/or inflexible nature of the dispenser housings and/or the flow control mechanisms (e.g., the gate valve and the motor-rotated cup), coupled with the substantially hard, coarsely-surfaced, brittle, and/or inflexible nature of the kibble itself. More broadly, from a system perspective, the combination of the utilized dispenser components and the reward might have lacked sufficient flexibility, smoothness, and/or lubricity to accommodate the physical nature of that reward, somewhat analogously to the “between a rock and a hard place” euphemism. It is currently believed that such systemic challenges can extend to many, if not most, of the nearly infinite combinations of other envisionable types of dispenser housings, flow control mechanisms, kibble, treats, and/or rewards.

Yet based on empirical evidence, it is currently believed that one or more of these challenges can be substantially overcome by utilizing a dispenser as described herein, and/or a legal equivalent thereof, which can comprise, in certain exemplary embodiments:
a helical spring-type auger that:
   is operatively adapted to convey treats;
   defines an open core;
   is manually malleable;
   is substantially polymer-covered; and/or
   is substantially flexible;
a motor that is:
   operatively mechanically coupled to said auger; and/or
   operatively electrically couplable to a power supply;
a treat repository operatively adapted to:
   store said treats; and/or
   cause said treats to contact said auger; and/or
a housing operatively adapted to:
   substantially surround said auger and/or said motor; and/or
   guide said treats from said treat repository to an outlet of said housing.

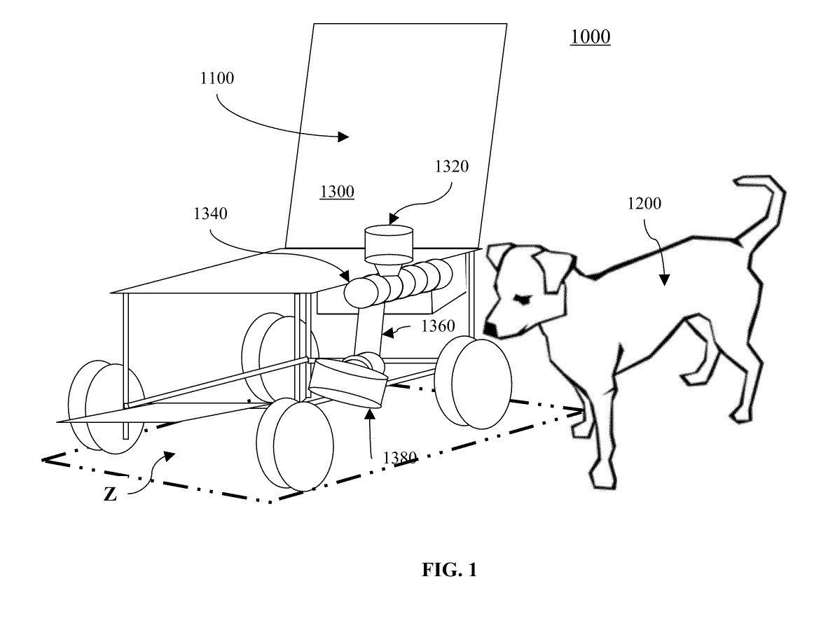

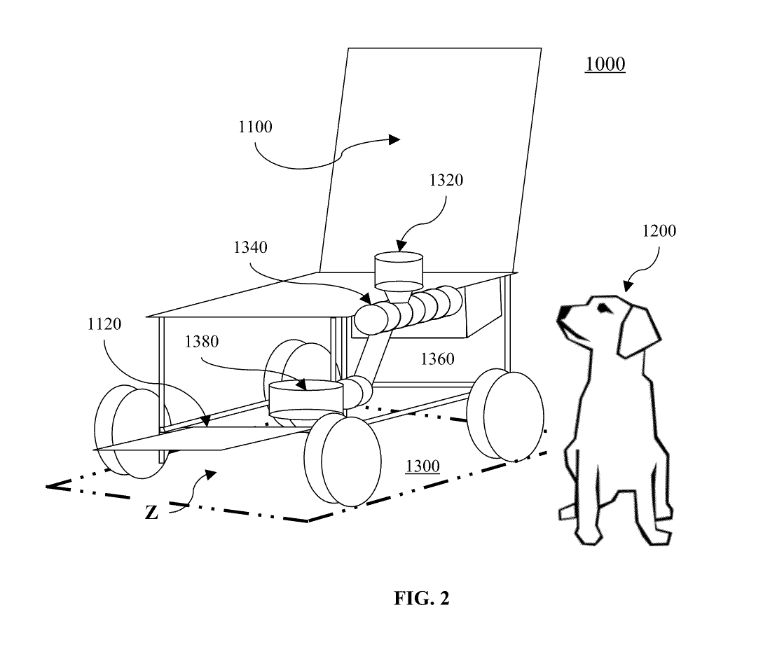

FIGS. 1 and 2 are perspective views of an exemplary embodiment of a system 1000, which can comprise a wheelchair 1100, a domesticated animal 1200, and/or a dispensing apparatus 1300 that can be releaseably attached to wheelchair 1100, which can seat, support, carry, and/or transport a human, in a manual, motorized, and/or semi-automated fashion. Dispensing apparatus 1300 can comprise a repository 1320, a flow control mechanism and/or actuator 1340, a chute 1360, and/or a receiver 1380, from which animal 1200 can retrieve whatever is dispensed by dispensing apparatus 1300.

Repository 1320 can receive, contain, and/or store a desired object, such as treats, pending motor-assisted, pneumatic-assisted, gravity-assisted and/or vibration-assisted feeding and/or delivering them to actuator 1340, which can actuate, such as upon demand of the wheelchair occupant and/or operator (and/or perhaps the animal and/or an information device, such as a smart phone, tablet computer, and/or robot, etc.) to convey objects received from repository 1320 via 1360 to receiver 1380, which can serve to prevent the objects from contacting the ground, being contaminated, staining a flooring, being crushed, rolling away, becoming lost, becoming a tripping hazard, being eaten by the intended recipient animal at an undesired time, and/or being eaten by an undesired animal, etc.

Note that due to the flexible, swivelable, rotateable, and/or adjustable configuration of the illustrated embodiment of apparatus 1300, the location of receiver 1380 with respect to wheelchair 1100, animal 1200, and actuator 1340 changes from FIG. 1 to FIG. 2, such that a portion of apparatus 1300 is located outside of a vertical projection Z of wheelchair 1100 in FIG. 1, yet the entirety of apparatus 1300 is located within that vertical projection Z in FIG. 2, thereby allowing receiver 1380 and/or at least a portion of apparatus 1300 to be moved from a position where it perhaps can be more accessible to animal 1200, to a position (e.g., within the vertical projection and/or outer boundaries of the wheelchair) where it can be less likely to be hit, impacted, damaged, etc., by, and/or cause impact and/or damage to, people, animals, items, and/or obstacles with which wheelchair 1100 comes near and/or contacts.

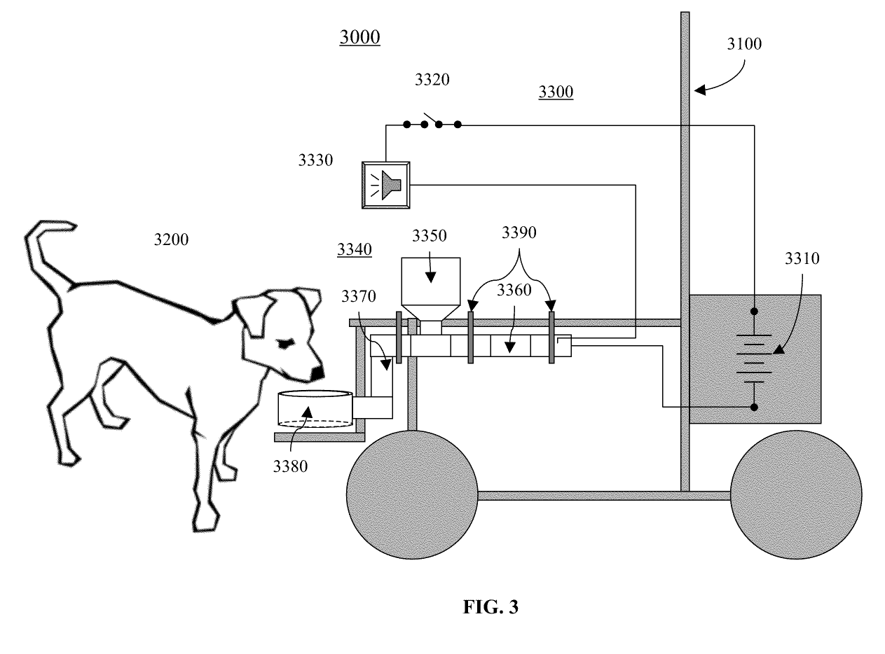

FIG. 3 is a schematic view of an exemplary embodiment of an system 3000, which can comprise a wheelchair 3100, an animal 3200, and/or a dispensing system 3300 that can be mechanically and/or electrically coupled to wheelchair 3100. Dispensing system 3300 can be electrically powered by a power supply 3310, such as a (DC) battery and/or a transformer coupled to an AC power source, that is internally located and/or externally located with respect to dispenser apparatus (“dispenser”) 3340. For example, power supply 3310 can be mounted on, in, and/or adjacent power wheelchair 3100.

A signal to dispenser 3340 and/or a flow of current from power supply 3310 to dispenser 3340 can be directly and/or indirectly controlled via a human, such as by the wheelchair operator and/or occupant (and/or possibly even by animal 3200 and/or an information device) via a switch 3320 (or a combination of switches). Switch 3320 can be, for example, an analog switch, single-pole switch, single-throw switch, double-pole switch, double-throw switch, 3-way switch, 4-way switch, momentary-on switch, polarity reversing switch, push-button style switch, rotary switch, selector switch, joystick switch, proximity switch, pressure switch, temperature switch, tilt switch, ribbon switch, grasp switch, leaf switch, flex switch, tip switch, plate switch, cup switch, cap switch, knife switch, lever switch, toggle switch, rocker switch, key switch, string switch, timed switch, latched switch, wired switch, wireless switch, remote switch, keyboard switch, electronic switch, binary switch, touch-screen-activated switch, tactile feedback switch, manual switch, foot-activated switch, sip and puff switch, pillow switch, cheek switch, chin switch, retinal tracker-activated switch, and/or thought-activated switch, etc., such as, for example, the wired, analog, single-pole, single-throw, push-button style, tactile feedback, manual, Tash MicroLight switch, available from AbleNet, Inc. of Roseville, Minn. In certain exemplary embodiments, switch 3320 can be, and/or can be actuated via, an information device, such as a MacBook, Mac Mini, iMac, iPod Touch, iPhone, and/or iPad, each available from Apple Inc. of Cupertino, Calif.

Current that flows from power supply 3310 can flow through a connecting wire (such as 24 AWG, 2 stranded conductor wire, which can be obtained via part number 100280 from Jameco Electronics of Belmont, Calif.), to activate an annunciator 3330, which can make a sound audible to animal 3200 and/or the human, thereby signifying that switch 3320 has been closed, preparing the animal for the reward, and/or providing even more rapid feedback to the animal than the reward itself. Exemplary annunciators can function and/or be constructed and/or be marketed as standard and/or piezoelectric buzzers, sirens, speakers, etc., and/or can include any of models 336225, 1956750, 1956661, 2098654, 336049, 123538, 336049, 335695, and/or 336997, which can be obtained from Jameco Electronics of Belmont, CA. Alternatively, the sound of the dispenser operating can provide sufficient feedback to the animal.

Electrical current that flows from power supply 3310 can power an electrically powered flow control mechanism and/or actuator, such as a linear solenoid, rotary solenoid, vibrator, AC induction motor, AC synchronous motor, stepper motor, brushed DC motor, brushless DC motor, coreless DC motor, pancake DC motor, universal motor, servo motor, linear motor, and/or electrostatic motor, that can be substantially located, for example, within dispenser 3340, such as within a dispensing portion 3360 of dispenser 3340. In the case of a linear solenoid, applied electrical power can be converted to linear motion of the solenoid's core, which can actuate a knife gate, plunger, and/or rack & pinion, etc. In the case of a rotary solenoid, applied electrical power can be converted to rotary motion of the solenoid's core, which can actuate a rotary cup, disk, scoop, flapper, auger, and/or screw, etc. In the case of a vibrator, applied electrical power can be converted to a vibrating mechanical motion, such as of dispenser 3340, repository 3350, and/or dispensing portion 3360. In the case of most motor types, applied electrical power can be converted to a rotation of the motor's output shaft (and/or the output shaft of a coupled gearbox, coupling, etc.), which in turn can rotate, for example, a cup, disk, scoop, flapper, auger, and/or screw that ultimately can tend to cause treats supplied by repository 3350 to move toward chute 3370, which can deliver one or more treats to receiver 3380, where the treats can be received, eaten, enjoyed, etc. by animal 3200.

Apparatus 3340 can be releaseably, removeably, and/or non-destructively mechanically coupled, mounted, and/or attached to a desired surface and/or thing, such as wheelchair 3100, a vehicle, a bicycle, a bed, a table, a wall, etc., via attachments 3390, which can be tape, strings, wires, cable ties, hook & loop fasteners, etc., which can allow apparatus 3340 to be available when and/or where needed, such as when the occupant is in wheelchair 3100, yet removable for cleaning, repair, relocation, etc. Alternatively, apparatus 3340 can be non-releaseably, non-removeably, and/or destructively removeably mechanically coupled, mounted, and/or attached to a desired surface and/or thing.

In certain exemplary embodiments, a dispenser, such as a dispenser described herein, can be releaseably, removeably, and/or non-destructively mechanically and/or communicatively coupled to, mounted to, attached to, contained within, and/or integral to, a robot. By pairing a robot with a service animal, the service animal can assist the robot with accomplish tasks and/or responding to challenges for which the robot is otherwise ill-equipped. By equipping the robot with a dispenser, in response to “sensed” inputs, predefined machine instructions stored in and/or accessible to the robot can actuate the dispenser as needed to attempt to control and/or motivate the service animal. Thus, for example, a robot might actuate a dispenser to train and/or reward a service animal for assisting the robot, such as by:
opening a door, pressing a button, and/or operating a switch for the robot;
picking-up, retrieving, and/or delivering an object, such as a difficult-to-grasp object that has been dropped;
seeking an electrical power source for the robot and/or connecting the robot thereto;
standing upright an off-balance and/or tipped-over robot;
freeing a “stuck” or mobility impaired robot;
responding to something the robot can not sense;
alerting the robot to a hazard;
protecting the robot from vandalism, mischief, and/or harm;
attracting human attention to the robot;
encouraging humans to interact with the robot; and/or
summoning help for the robot;
etc.

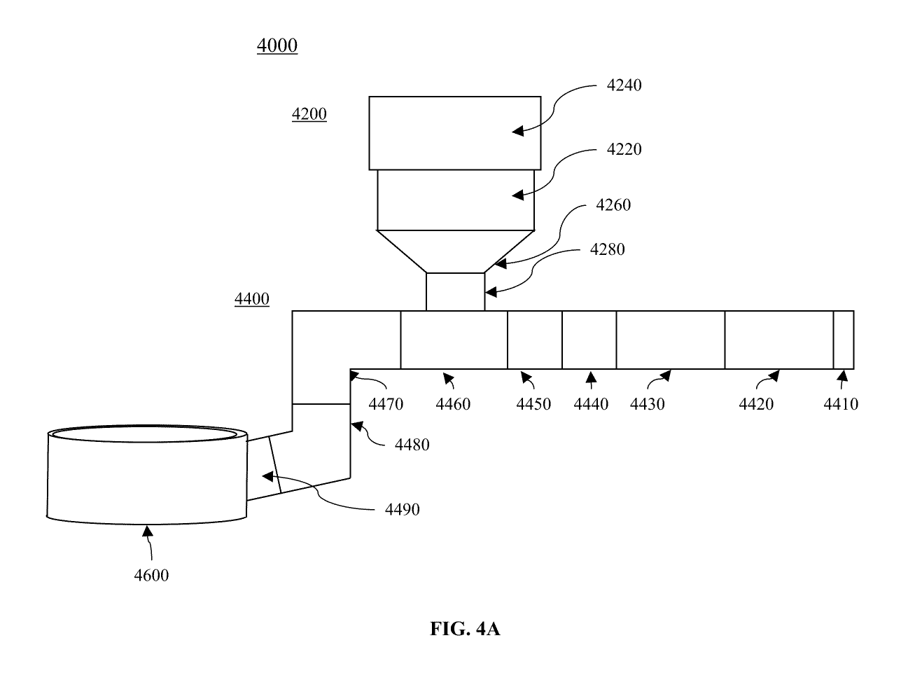

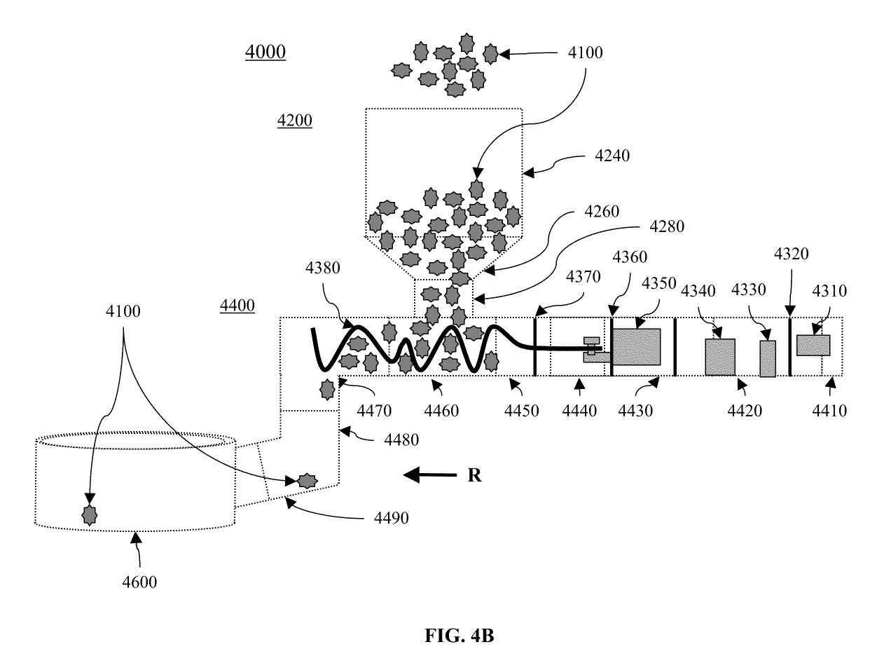

FIG. 4A is a side view of certain normally externally-visible components and/or portions of an exemplary embodiment of a dispensing apparatus 4000, which can comprise a repository 4200 coupled to a housing 4400, which can terminate at and/or be coupled to a receiver 4600, any of which can be formed primarily from, for example, schedule 10, schedule 20, and/or schedule 40, slip joint, glueable, and/or threaded, metal, PVC, and/or other polymer, pipe, tubing, and/or electrical conduit sections and/or fittings, such as those available from an electrical, plumbing, and/or home improvement supply store and/or supplier, such as Lowe's, Home Depot, etc.

For repository 4200, a 3″ cap 4220 (all fitting sizes presented as nominal diameter) can serve as a protective cover over a 6″ long section of 3″ pipe that can function as canister 4240, to which a 3″×1.5″ reducer 4260 can be coupled to direct contents of canister 4240 generally toward housing 4400, and to which can be coupled to a short section of 1.5″ pipe 4280 (which can serve to fluidly connect reducer 4260 to housing 4400 and/or allow housing 4400 to support the weight of canister 4240 and its connected fittings), such that via cap 4220, canister 4240, reducer 4260, and/or pipe 4280, the contents of canister 4240 can be substantially protected from spilling, contamination, weather, and/or premature access by the animal and/or other animals, etc.

For housing 4400, a 1.5″ pipe cap 4410, which can serve to close one end of housing 4400, can couple via a short section of 1.5″ pipe and/or a 1.5″ plug (modified as needed to accommodate the fittings it is intended to couple, such as by grinding down as needed its lip, extensions, and/or protrusions, etc.) to a 1.5″ long coupling 4420, which can couple in a similar manner to another 1.5″ long coupling 4430, which can couple in a similar manner to a 1.5″ short coupling 4440, which can couple in a similar manner to another 1.5″ short coupling 4450, which can coupled in a similar manner to a 1.5″ tee 4460. Any of the just-mentioned couplings can serve to substantially surround certain components of dispensing apparatus 4000. The branch of tee 4460 can be coupled to reducer 4260 of repository 4200 via pipe section 4280. The longer straight-through portion of tee 4460 can couple in a similar manner to a 1.5″ 90 degree elbow 4470. Tee 4460 can serve to substantially surround and/or contain an auger and/or other actuator of the dispensing apparatus, convert substantially vertical treat flow direction to a substantially horizontal flow direction, and/or merge and/or couple an actuator portion of housing 4400 with a treat conveyance portion, etc. Elbow 4470 can direct treats from auger and/or actuator portion of housing 4400 to a chute 4480 and/or treat conveyance portion, transfer the weight of the treat conveyance portion to the actuator portion (and thereby to any attachments of housing 4400 and/or dispensing apparatus 4000). The generally downward projecting end of elbow 4470 can couple in a similar manner to chute 4480, which can serve to direct treats from the actuator (e.g., cup, disk, scoop, flapper, auger, and/or screw, etc.) to repository 4200, fluidly and/or mechanically couple the horizontal portion and/or actuator portion of housing 4400 to repository 4200, and/or mechanically support the weight of repository 4200. Chute 4480 can be formed from a 1.5″ 60 degree elbow and/or to 1.5″ 45 degree elbow coupled in a similar manner to a 1.5″ 22.5 degree elbow, which can couple in a similar manner to a 1.5″ adapter 4490 having a threaded end portion and a corresponding nut. The terminal and/or threaded end portion of adapter 4490 can protrude through an approximately 1.5″ hole in the side of a 4″ pipe cap (which can serve as a bowl and/or treat receiver 4500), and the corresponding nut can serve to secure the cap to the adapter, thereby coupling treat receiver 4500 to an outlet of housing 4400.

Any of the various fittings of dispensing apparatus 4000 can, in various exemplary embodiments, destructively, non-destructively, slideably, threadable, rotateably, non-rotateably, adjustably, rigidly, fixedly, glueably, resistively, disassemblably, releaseably, and/or non-releaseably couple via unglued, glued, caulked, and/or taped slip joint, threaded joint, locked joint, loose fit, slip fit, close fit, threaded fit, running fit, force fit, locked fit, and/or press fit, etc. Any of the resulting mechanical connections can be resistant to assembly, assembled, locked, released, non-adjustable, linearly adjustable, rotationally adjustable, angularly adjustable, positionally adjustable, rotated, rotateable, resistant to disassembly, destructively releaseable, non-destructively releaseable, destructively disassembled, and/or non-destructively disassembled, etc. Surface roughening and/or thread tape can be applied to one or more fitting surfaces located within and/or that form a threaded and/or slip fit joint to help secure that joint from, and/or increase resistance of the joint to, inadvertent and/or undesired disassembly. Glue, caulk, and/or tape or the like can be applied to one or more interior and/or exterior fitting surfaces located at and/or near a joint to help secure that joint from, and/or increase resistance of the joint to, inadvertent and/or undesired disassembly. One or more pins and/or screws can penetrate and/or impose on one or both coupled fittings to help releaseably lock and/or secure a joint from, and/or increase resistance of the joint to, inadvertent and/or undesired disassembly. Certain exemplary embodiments can provide the ability to non-destructively adjust a joint when desired, such as to change an orientation of all and/or a portion of the apparatus. Certain exemplary embodiments can provide the ability to non-destructively disassemble a predetermined joint when desired, such as to clean one or more fittings, clear a treat jam, adjust an auger dimension and/or shape, and/or adjust, optimize, repair, and/or replace mechanical and/or electrical components, etc. In certain exemplary embodiments, two or more fittings described above and/or herein can be implemented as a single, combined, unitary, and/or monolithic component.

FIG. 4B is a side view of certain normally externally non-visible and/or internal components and/or portions of an exemplary embodiment of dispensing apparatus 4000, which can comprise a battery 4310, such as a standard 9 volt battery, which can be electrically coupled to a switch jack 4330 (which can be obtained via product number 2081238 from Jameco Electronics) to electrically power dispensing apparatus 4000. Note that to facilitate easy replacement of battery 4310 and/or protection of various electrical connections during replacement of battery 4310, battery 4310 can be substantially physically separated from jack 4330 via a partition 4320, which in some exemplary embodiments can be formed by the end portion of a 1.5″ PVC plug-type pipe fitting, by a substantially circular piece of PVC house siding, and/or by a substantially circular piece of polyethylene, etc., having a small hole through which conductive wires can extend to connect to battery 4310. Although not shown in FIG. 4B, a switch for electrically completing a circuit involving battery 4310 can be releaseably connectable to jack 4330 via an attached jack-compatible plug.

Jack 4330 can be electrically coupled to an annunciator 4340, which can be used for purposes described herein, and/or which can be electrically coupled to a motor 4350, such as a direct current (DC), reversible, and/or gearhead motor, which: can operate at a voltage of approximately 6 volts to approximately 30 volts, including all values and sub-ranges therebetween, such as approximately 6 volts to approximately 15 volts, approximately 9 volts to approximately 12 volt, etc.); can rotate its output shaft at a relatively low angular speed (e.g., approximately 2 rpm (revolutions per minute) to approximately 400 rpm, including all values and sub-ranges therebetween, such as approximately 30 rpm to approximately 300 rpm, approximately 51 rpm to approximately 202 rpm, etc.); and/or can provide via its output shaft a relatively high torque at maximum efficiency, (e.g., approximately 50 g-cm to approximately 10000 g-cm, including all values and sub-ranges therebetween, such as approximately 350 g-cm to approximately 2200 g-cm, approximately 600-1300 g-cm, etc.); such as, for example, a Jameco Electronics model 161382, 155855, and/or 161374.

Motor 4350, which can be used to convert electrical power to rotating mechanical power, can be mounted to a partition 4360, which can be similar to partition 4320 in composition, structure, dimensions, and/or general function. Partition 4360 can secure motor 4350 to housing 4200, thereby preventing motor 4350 from rotating instead of and/or in addition to its output shaft and/or thereby encouraging the output shaft of motor 4350 to rotate with respect to the housing of motor 4350.

Mechanically coupled to motor 4350 can be an actuator, such as a cup, disk, scoop, flapper, auger, and/or screw. For example, motor 4350 can be mechanically coupled to an auger 4360, which can be formed from, for example, a single-conductor electrical cable (e.g., 12/1 AWG Romex), multi-conductor electrical cable (e.g., 14/2 AWG Romex), multi-conductor insulated telephone cable, co-axial cable television cable, Ethernet Category 5 networking cable, IEEE 1394 (Firewire) serial computer device cable, USB cable, video cable, hose, tube, plastic pipe, and/or polymeric material, elastomeric material, wire, etc. In certain exemplary embodiments, auger 4360 can be cut, extruded, stamped, tooled, formed, manually shaped, and/or coiled into a desired shape, and/or can be manually re-shaped as desired. In certain exemplary embodiments, auger 4360 can substantially resemble a helical spring and/or can possess a moderate degree of shape memory, thereby allowing it to moderately flex, yet return to a predetermined formed and/or coiled shape, in response to certain forces that can be applied to it by motor 4350 and/or the treats. Auger 4360 can define a longitudinal and/or rotational axis, which, in operation, can be oriented substantially horizontally, substantially diagonally, and/or substantially vertically. In certain exemplary embodiments, auger 4360 can define an open core, thereby allowing treats to reside within the inner circumference and/or outside the outer circumference of auger 4360, which can increase the surface area of auger 4360, provide a larger cross-section flow area for the treats, allow auger 4360 to flex more easily, decrease any tendency of auger 4360 to crush the treats, decrease jamming of auger 4360 and/or motor 4350, etc. Auger 4360 can define a plurality of uniform and/or non-uniform coils. That is, in certain exemplary embodiments, lengthwise along any given coil, the inner diameter can vary, the outer diameter can vary, the pitch can vary, and/or the thickness of auger 4360 can vary, and/or any of those variations can be applied and/or changed manually, which can allow auger 4360 to be dimensioned, adjusted, repaired, and/or optimized to accommodate changes and/or variations in sizes, quantities, densities, types, and/or mixtures of treats; changes and/or variations in coiled and/or uncoiled auger lengths; changes and/or variations in housing diameters and/or one or more dispenser dimensions; changes and/or variations in auger and/or housing materials of construction; etc. In certain exemplary embodiments, auger 4360 can be substantially formed, covered, sheathed, and/or jacketed by a substantially electrically non-conductive, non-metallic, and/or polymer material, which can protect auger 4360 from abrasion by treats, control friction between auger 4360 and the treats it can convey, and/or protect auger 4360 from abrasion caused by contact with the housing and/or any component thereof.

Auger 4360 can comprise one or more members (“backbones”) that can be manually malleable, electrically conductive, and/or metallic, and/or which can allow the shape of auger 4360 to be relatively easily manually adjusted to a desired shape yet provide auger 4360 with a desired degree of shape memory, which can allow auger 4360 to substantially retain and/or return to the desired shape in response to treat- and/or motor-generated forces, facilitate clearing treat jams, and/or allow changing and/or optimizing the length of auger 4360, diameter(s) of one or more of its coils, widths of one or more its coils, and/or spacing(s) and/or pitch of one or more its coils.

When auger 4360 comprises more than one backbone, each additional backbone can add additional strength, flexibility, shape memory, and/or fatigue resistance to auger 4360. Moreover, each of those backbones can be substantially parallel. That is, the backbones can have similar shapes and/or exhibit a substantially uniform spacing with respect to each other along the length of auger 4360, so that auger 4360 can function, in at least some respects, as a single-flighted and/or single-backboned auger despite having multiple “internal” flights and/or backbones.

Any of the backbones of auger 4360 can be individually covered, sheathed, and/or jacketed by a polymer material, which can help prevent and/or lessen contact between the backbones, lower friction between the backbones, maintain relative positioning of the backbones within auger 4360, maintain parallelism of the backbones, maintain a substantially uniform spacing between the backbones along the length of auger 4360, etc.

Relative movement and/or rotation of auger 4360 with respect to housing 4400, can cause apparent motion of the (outer, external, apparent, single, and/or combined) flight of auger 4360 substantially in direction R (although the opposite rotation and apparent motion is also possible), which can urge treats received from repository 4200 toward chute 4480 and/or receiver 4600, where the treats can be retrieved by the animal.

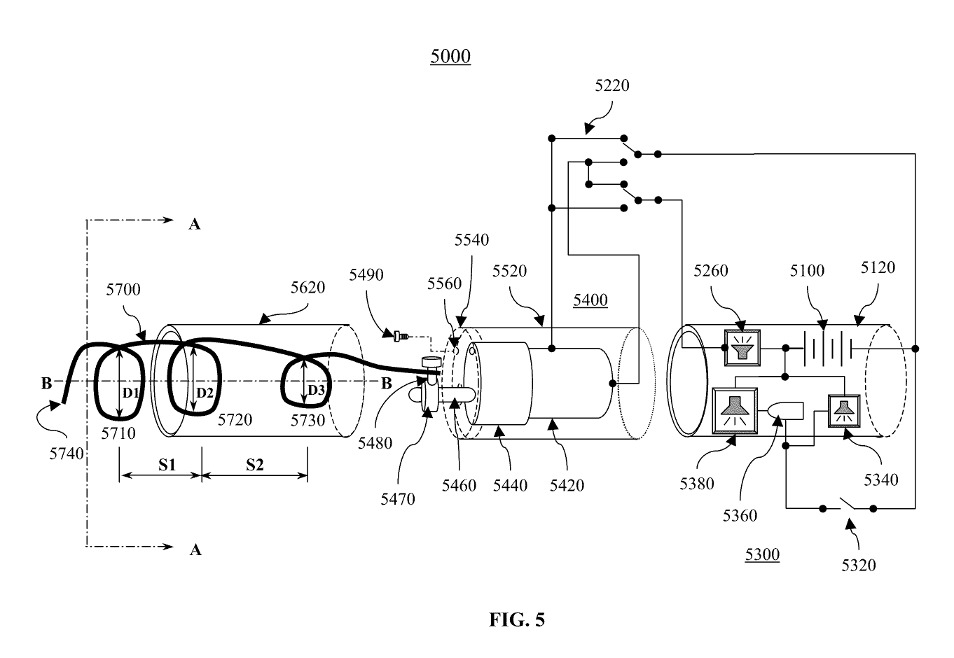

FIG. 5 is a schematic view of certain components of an exemplary embodiment of an apparatus 5000, such as a treat dispenser. Apparatus 5000 can comprise and/or be electrically coupled to a power supply 5100, which can be, for example, a standard 9 volt alkaline, lithium, nickel-metal hydride battery having miniature snap electrical connectors, and/or a 12 volt sealed lead acid battery. Power supply 5100 can be located within an electrical component housing 5120 of apparatus 5000 or outside of electrical component housing 5120.

Power supply 5100 can be electrically coupled to a switch 5220, such as a single-pole, single throw, (On)-Off-(momentary-On) switch, which, via its manual activation, can allow a user to temporarily electrically activate, turn on, and/or allow current to flow to, motor 5400. In certain exemplary embodiments, switch 5220 can be a double-pole, double throw, (On)-Off-(On) (e.g., momentary-On, momentary-Reverse) switch, which, via its actuation, can allow a user to reverse current direction, thereby causing the output shaft 5460 of motor 5400 to reverse its direction of rotation, which can be helpful for clearing treats that have jammed within auger housing 5620. In certain exemplary embodiments, switch 5220 can comprise a serial combination of switches, such as a single-pole, single throw, momentary-on switch electrically coupled in series with a double-pole, double throw, On-Off-On switch, where the single-pole switch is normally used for electrically activating motor 5400, and the double-pole switch can be changed from one On position to the other to reverse the rotational direction of output shaft 5460 upon temporary manual actuation of the single-pole switch.

Even when manually rewarding an animal for demonstrating a desired behavior and/or approximation thereof, there can be at least a small time delay from the time a human seeks to reward the animal and the time the reward is actually presented to the animal. The longer that delay, the greater can be the attenuation in the animal's association of the reward with the desired behavior. That is, the slower the delivery of the reward, the less likely the animal might be to link the reward with the desired behavior, and the more training that might be needed to create that link. To help alleviate and/or reduce that issue, the human can provide a predetermined sound promptly upon recognition that the animal has performed and/or approximated the desired behavior, and then can follow-up shortly thereafter by presenting the reward. The sound can signal to the animal that the animal has performed a desired behavior, and/or that a reward will come relatively soon. This approach can be effective when the sound can be generated considerably quicker than the reward can be delivered, which can be the situation in the case of certain exemplary embodiments.

That is, certain exemplary embodiments can manifest a delay from the time the human and/or operator actuates the switch to activate motor 5400 until the treat is presented to the animal. In certain exemplary embodiments, coupled electrically in series with motor 5400 can be one or more annunciators 5260, as described herein, which can serve to, in normal operation, make a predetermined noise when electrically activated. This noise can notify the human that switch 5220 has been actuated, alert the animal that a treat will soon follow, thereby allowing the human to more closely temporally link the animal's desired behavior with the reward, cause the animal to position itself to retrieve the treat, and/or promptly reinforce the desired behavior.

Motor 5400 can comprise a motor portion 5420 that is adapted to convert electrical energy to mechanical rotation, and/or a gearhead portion 5440 that is adapted to reduce the angular speed of that rotation, which can help prevent dispensing too many treats, dispensing treats too rapidly, damaging treats and/or dispenser components, etc. Thus, although motor portion 5420 can rotate at, for example, 1800 rpm, 3600 rpm, and/or 7200 rpm, etc. (including any value and/or subrange therebetween) in normal operation, the output shaft 5460 of gearhead portion 5440 can rotate at, for example, 30 rpm, 60 rpm, 90 rpm, 150 rpm, or 240 rpm, etc. (including any value and/or subrange therebetween).

Gearhead portion 5440 of motor 5400 can be mechanically attached to a end portion 5540 of motor housing 5520 via one or more screws 5490 that each fit through a corresponding hole 5560 in end portion 5540 and into a corresponding hole in the body of motor 5400, thereby resisting relative motion between the body of motor 5400 and end portion 5540 and/or housing 5520. That is, in normal operation, when motor 5400 is activated, output shaft 5460 can rotate with respect to end portion 5540, motor portion 5420, and/or motor housing 5520.

A shaft coupling 5460, such as a model 138288 and/or 162270 from Jameco Electronics, can be used to mechanically couple output shaft 5440 to auger 5700, so that, in normal operation, auger 5700 tends to rotate when output shaft 5440 rotates. Shaft coupling 5460 can be substantially annular in shape, with the annular hole larger in diameter than the outer diameter of output shaft 5440, so that shaft coupling 5460 can easily fit over the outer diameter of output shaft 5440. Shaft coupling 5460 can also define a threaded set screw hole that can extend perpendicular to the annular hole, that is, from a outer circumferential side of shaft coupling 5460 to an inner side of shaft coupling 5460, and/or that is adapted to receive a set screw that can be used to securely fasten shaft coupling 5460 to output shaft 5440. That set screw can be replaced with a machine screw 5480 having a similar thread diameter and/or pitch. The shaft of machine screw 5480 can extend through a hole drilled and/or bored through auger 5700, and/or through a hole in a ring terminal that can be crimped onto an end of auger 5700. The length of the machine screw can be selected and/or adjusted so that machine screw 5480 can, in normal operation: threadably extend through the set screw hole of shaft coupling 5460, releaseably fasten shaft coupling 5460 to output shaft 5440, and/or releasably mechanically couple auger 5700 to output shaft 5440, so that when output shaft 5440 rotates, auger 5700 also tends to rotate in substantially the same rotational direction and at approximately the same angular speed.

Auger 5700 can comprise a plurality of coils that can have a uniform and/or non-uniform outer diameter, inner diameter, width, and/or inter-coil spacing. For example, the inner diameter D1 of coil 5710 can differ from the inner diameter D2 of coil 5720 and/or the inner diameter D3 of coil 5730, and/or the spacing 51 between coil 5710 and coil 5720 can differ with the spacing S2 between coil 5720 and coil 5730. Alternatively, a first sub-plurality of coils can have uniform outer diameter, inner diameter, width, and/or inter-coil spacing, and a second sub-plurality of coils can have non-uniform outer diameter, inner diameter, width, and/or inter-coil spacing. Moreover, because auger 5700 can be manually malleable, the outer diameter, inner diameter, width, and/or inter-coil spacing can be manually varied as desired, which can allow auger 5700 to be field-adjusted to accommodate, experiment with, and/or be optimized based on: changes and/or variations in sizes, quantities, densities, types, and/or mixtures of treats; changes and/or variations in coiled and/or uncoiled auger lengths; changes and/or variations in housing diameters and/or one or more dispenser dimensions; changes and/or variations in auger and/or housing materials of construction; etc.

Auger housing 5620 can define a substantially horizontally-oriented longitudinal axis B. In normal operation, a free end 5740 of auger 5700 can rotate freely, that is, without direct connection to any fixed element, yet generally can be substantially constrained in that rotation by auger housing 5620 such that free end 5740 rotates substantially about an auger core longitudinal axis that is substantially parallel to and/or co-axial with auger housing longitudinal axis B. Leaving free end 5740 substantially free can allow for simpler construction of apparatus 5000 and/or auger 5700, field adjustments to, experimentation with, and/or optimization of, the length, coil diameter, and/or coil spacing of auger 5700, easier resolution of treat jams, and/or easier cleaning of the interior of auger housing 5620.

In certain exemplary embodiments, power supply 5100 can provide electrical current to a panic alarm circuit 5300, which can comprise a panic switch 5320, such as a single-pole, single-throw, momentary on switch. In normal operation, to indicate and/or provide a local warning that panic switch 5320 has been activated, panic switch 5320 can allow electrical current to flow to an indicator light and/or to warning annunciator 5340, which can substantially immediately produce a sound at a moderate sound pressure level (e.g., approximately 70 dB to approximately 90 dB measured e.g., directly in front of and/or within approximately 6 inches of annunciator 5340) and/or at a sound pressure level sufficient to indicate and/or provide a local warning that panic switch 5320 has been activated. In normal operation, to allow sufficient time after warning annunciator has begun sounding to release panic switch 5320 and thereby to prevent panic annunciator 5380 from sounding, when activated, panic switch 5320 can allow electrical current to flow to delay timer 5360, which can allow electrical current to flow to panic annunciator 5380 after a predetermined and/or programmed delay time, such as a selected time between approximately 1 second and approximately 30 seconds (including all values and sub-ranges therebetween), such as approximately 3 seconds, 5 seconds, etc. When activated, panic annunciator 5380 can produce a relatively loud, distinct, and/or noticeable sound that can be sufficient to draw the attention of other humans to the general location of apparatus 5000 and/or the human and/or animal that activated its panic alarm. Such a panic alarm can be useful when the dispenser operator needs and/or desires particular attention and/or emergency assistance when an assistant and/or caregiver is pre-occupied, out of sight, and/or not immediately available. In certain exemplary embodiments, the panic alarm circuit and/or its switch can be adapted to be activated by the animal, such as upon verbal and/or visual prompting, and/or by an information device, under human and/or programmatic control.

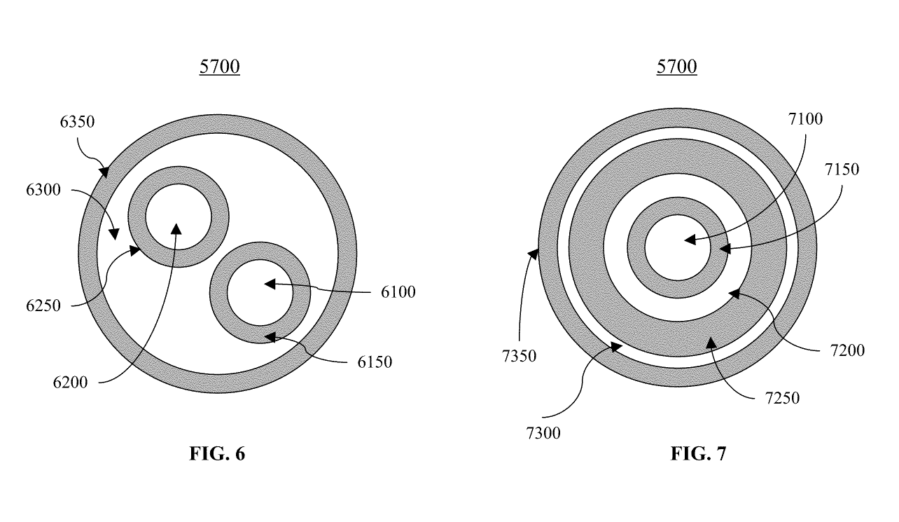

FIG. 6 is a section view of a first exemplary embodiment of an auger 5700 taken at section A-A of FIG. 5, and showing a first backbone 6100, which can have a jacket 6150, a second backbone 6200, which can have a jacket 6250, a surrounding filler material and/or space 6300, and an outer auger jacket 6350. In this embodiment, first backbone 6100 is not longitudinally co-axial with second backbone 6200, yet can be substantially parallel to it.

FIG. 7 is a section view of a second exemplary embodiment of an auger 5700 taken at section A-A of FIG. 5, and showing a first backbone 7100, which can have a jacket 7150, a second backbone 7200, which can have a jacket 7250, a surrounding filler material and/or space 7300, and an outer auger jacket 7350. In this embodiment, first backbone 7100 can be longitudinally co-axial with second backbone 7200, as well as substantially parallel to it.

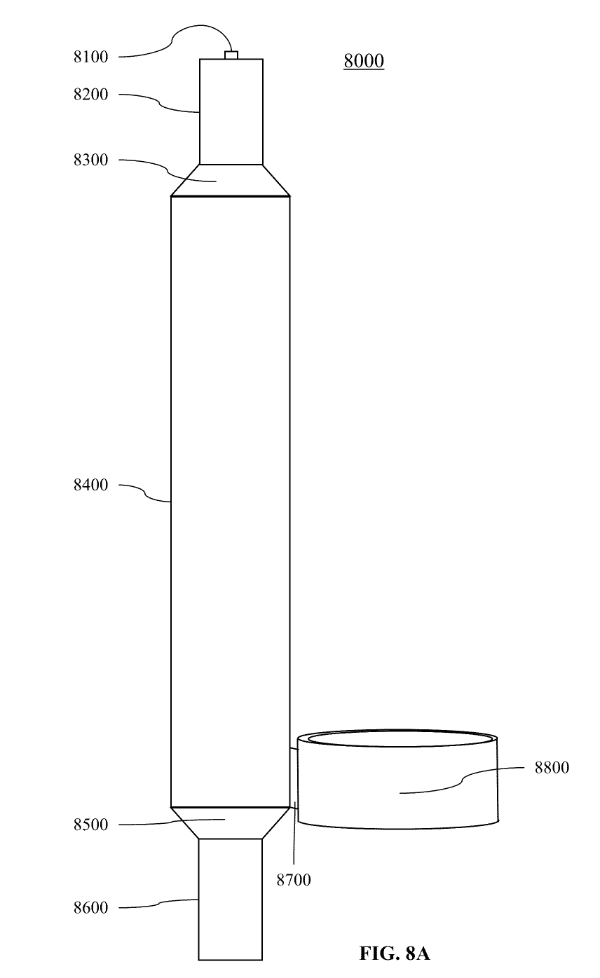

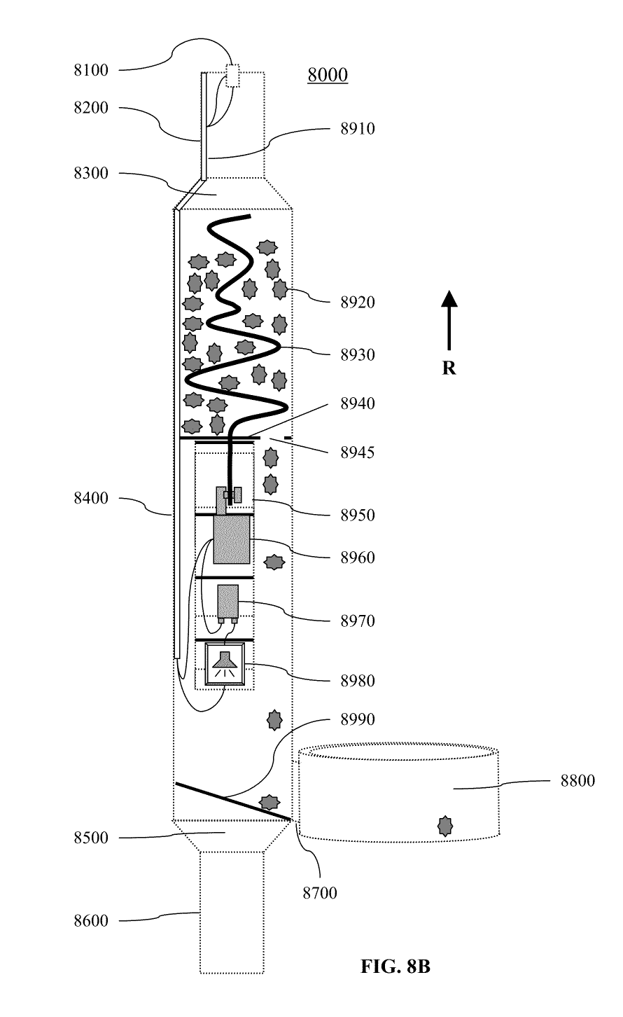

FIG. 8A is a side view of certain normally externally visible components and/or portions of an exemplary embodiment of a walking stick apparatus 8000 that can comprise a vertically oriented treat dispenser. Apparatus 8000 can serve to help prevent a human from falling and/or slipping, such as while walking Apparatus can serve as a handy means for dispensing treats to an animal accompanying a human without the human directly manually dispensing those treats.

Apparatus 8000 can comprise a switch 8100, such as described herein, which can be, for example, a single-pole, single-throw, momentary on, push button switch. In normal operation, switch 8100 can be mounted in and/or attached to a handle 8200, which can provide a surface via which a human can grip apparatus 8000, and/or which can be mechanically coupled as described herein, such as via a short section of pipe and/or a plug, to a reducer 8300, which can be mechanically coupled as described herein to an external housing 8400, which can be mechanically coupled as described herein to a reducer 8500, which can be mechanically coupled as described herein to a foot 8600, which can provide a ground-contacting member for apparatus 8000, and/or can bear the weight of apparatus 8000 and/or a human using apparatus 8000, etc.

In normal operation, a chute 8700 can be mechanically coupled as described herein to external housing 8400 and/or to receiver 8800 to direct treats from within external housing 8400 to receiver 8000. Any of handle 8200, reducer 8300, external housing 8400, reducer 8500, foot 8600, chute 8700, and/or receiver 8800 can, for example, be formed and/or function substantially as described herein, that is, can be formed primarily from, for example: schedule 10, schedule 20, and/or schedule 40; slip joint and/or threaded; metal, PVC, and/or other polymer; pipe, tubing, and/or conduit sections and/or fittings.

In certain exemplary embodiments, handle 8200, foot 8600, and/or chute 8700 can be formed from, for example, fittings having a nominal diameter and/or actual outer diameter of from approximately 0.375″ to approximately 2″, including all values and sub-ranges therebetween. External housing 8400 can be formed from, for example, fittings having a nominal diameter and/or actual outer diameter of from approximately 0.5″ to approximately 4″, including all values and sub-ranges therebetween. Receiver 8800 can be formed, for example, substantially as described herein, such as from a fitting, such as a cap, having a nominal diameter and/or actual outer diameter of from approximately 2″ to approximately 6″, including all values and sub-ranges therebetween. External housing 8400 can serve to contain treats within apparatus 8000; protect treats from spilling, contamination, weather, and/or premature access by the animal and/or other animals, etc.; protect the motor and/or other electrical components from weather, abuse, short circuits, causing electrical shock to a human and/or animal, etc.; connect handle 8200 to foot 8600; fluidly and/or mechanically couple the repository and/or canister portion of external housing 8400 to chute 8700, and/or mechanically support the weight of chute 8700 and/or receiver 8800. Chute 8700 can serve to direct treats from within external housing 8400 to receiver 8800, fluidly and/or mechanically couple external housing 8400 to receiver 8800, mechanically support the weight of receiver 8800, and/or protect treats from spilling, contamination, weather, and/or premature access by the animal and/or other animals, etc.

FIG. 8B is a side view of certain normally externally non-visible and/or internal components and/or portions of an exemplary embodiment of a treat dispensing walking stick apparatus 8000, which can comprise a protective conductor channel 8910, which can serve to protect from treat-caused abrasion electrical conductors that can extend, for example, from switch 8100 to DC gearhead motor 8960, DC power supply 8970, and/or annunciator 8980, any of which can be electrically interconnected, any of which can be substantially enclosed by an internal housing 8950 (which can be embodied substantially as described herein (e.g., using PVC fittings, etc.)), and/or any of which can be embodied substantially as described herein. Alternatively, switch 8100 can be a wireless switch (thereby reducing and/or eliminating a need for conductors connected directly thereto) that can wirelessly transmit an activation signal to a wireless receiver that can be wired via conductors to DC gearhead motor 8960, DC power supply 8970, and/or annunciator 8980.

Internal housing 8950 and/or motor 8960 can be mechanically coupled, for example, substantially as described herein, to a support plate and/or partition 8940, which can be mechanically coupled, for example, substantially as described herein, to external housing 8400. Through partition 8940 can extend a hole sufficiently sized to accommodate an output shaft of motor 8960. Through partition 8940 can extend a hole 8945 sufficiently sized to, upon actuation of switch 8100, allow rewards and/or treats to pass substantially freely therethrough. Motor 8960 can be mechanically coupled, for example, substantially as described herein, to auger 8930, which can define a longitudinal and/or rotational axis that can be oriented substantially vertically. In normal operation, upon activation of motor 8960, auger 8930 can rotate, causing apparent motion of the (outer, external, apparent, single, and/or combined) flight of auger 8930 substantially in direction R (although the opposite rotation and apparent motion is also possible), which can thereby sufficiently disrupt and/or interrupt bridging and/or jamming of treats 8920 so that at least some treats can fall through hole 8945 before bridging and/or jamming resumes. In normal operation, upon deactivation of motor 8960 and/or cessation of rotation of auger 8930, a sufficient number of treats 8920 can bridge and/or jam to thereby reduce and/or eliminate the flow of treats 8920 through hole 8945. In an alternative embodiment, auger 8930 can be augmented by and/or replaced by a vibrator, pneumatic blaster, loudspeaker, linear solenoid, etc., that can temporarily disrupt bridging and/or jamming, thereby allowing at least some treats 8920 to fall and/or flow through hole 8945.

In normal operation, after falling through hole 8945, treats 8920 can impact and/or encounter a sloped ramp 8990, which can guide treats 8920 into chute 8700, and thereby into receiver 8800. Ramp 8990 can be formed, for example, from a piece of PVC pipe cut lengthwise to create a ramp-like and/or trough-like structure, and/or from a piece of vinyl siding that has been curled, angled, and/or trimmed to fit within housing 8400. In certain exemplary embodiments, ramp 8990 can be combined with chute 8700 to form a single, unitary, and/or monolithic component. In certain exemplary embodiments, chute 8700 can be eliminated and receiver 8800 can be directly connected to external housing 8400.

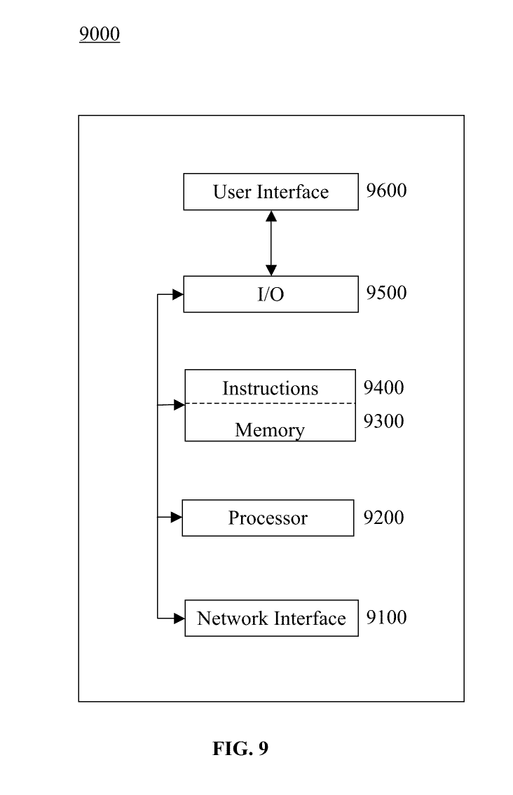

FIG. 9 is a block diagram of an exemplary embodiment of an information device 9000, which in certain operative embodiments can serve as a switch. Information device 9000 can comprise any of numerous transform circuits, which can be formed via any of numerous communicatively-, electrically-, magnetically-, optically-, fluidically-, and/or mechanically-coupled physical components, such as for example, one or more network interfaces 9100, one or more processors 9200, one or more memories 9300 containing instructions 9400, one or more input/output (I/O) devices 9500, and/or one or more user interfaces 9600 coupled to I/O device 9500, etc.

In certain exemplary embodiments, via one or more user interfaces 9600, such as a graphical user interface, a user can view a rendering of information related to researching, designing, modeling, creating, developing, building, manufacturing, operating, maintaining, storing, marketing, selling, delivering, selecting, specifying, requesting, ordering, receiving, returning, rating, and/or recommending any of the products, services, methods, user interfaces, and/or information described herein.

For example, via a user interface 9600, such as a touch screen, a user can enter a gesture that the information device can interpret as a request to send a signal to, for example, energize and/or activate a motor of a treat dispenser, reverse a direction of that motor, activate a vibrator that can vibrate an auger, treats, and/or housing associated with that motor and/or an apparatus, activate a timer, activate an annunciator, activate a circuit, delay activation, cancel activation, compose a communication, transmit a communication, retrieve a communication, gather data and/or information, store data and/or information, query data and/or information, display data and/or information, transmit data and/or information, actuate a still camera and/or a video camera, display a photo and/or video, actuate a sound recorder, and/or play a sound recording, etc.

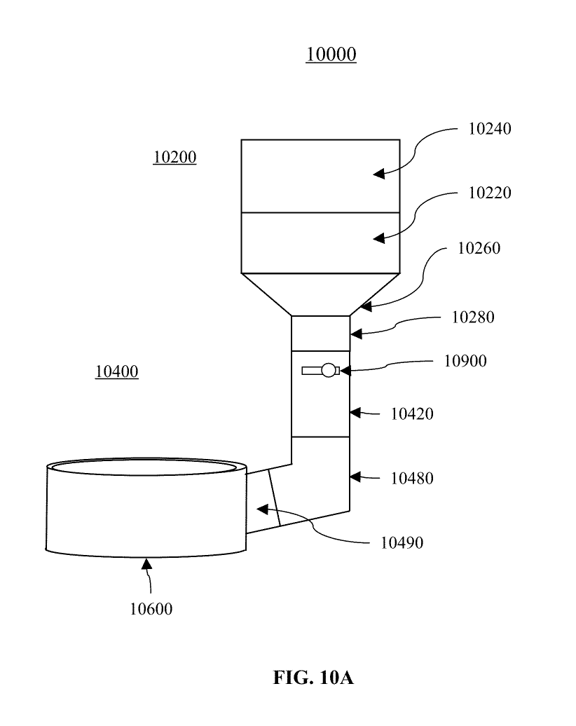

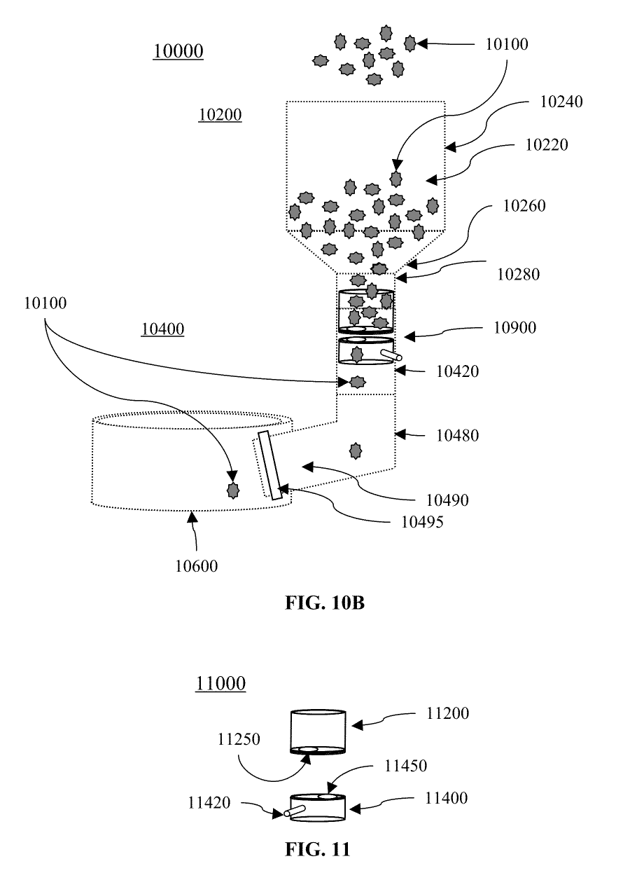

FIG. 10A is a side view of certain normally externally-visible components and/or portions, and FIG. 10B is a side view of certain normally externally non-visible and/or internal components and/or portions, of an exemplary embodiment of a dispensing apparatus 10000, which can comprise a repository 10200 coupled to a chute 10400, which can terminate at and/or be coupled to a receiver 10600, any of which can be formed primarily from, for example, schedule 10, schedule 20, and/or schedule 40, slip joint, glueable, and/or threaded, metal, PVC, and/or other polymer, pipe, tubing, and/or electrical conduit sections and/or fittings, substantially as described herein.

For repository 10200, a 3″ cap 10240 (all fitting sizes presented as nominal diameter) can serve as a protective cover over an approximately 6″ long section of 3″ pipe that can function as canister 10220, to which a 3″×1.5″ reducer 10260 can be coupled to direct contents 10100 of canister 10220 generally toward chute 10400, and to which can be coupled to a 1.5″ coupling 10420 (which can serve to fluidly connect reducer 10260 to chute 10400 and/or allow chute 10400 to support the weight of repository 10200 and/or its associated and/or connected fittings), such that via cap 10240, canister 10220, reducer 10260, and/or coupled 10420, the contents 10100 of canister 10220 can be substantially protected from spilling, contamination, weather, and/or premature access by the animal and/or other animals, etc.

Chute 10400 can serve to direct contents 10100, such as treats, from repository 10200 to receiver 10600, and/or mechanically support the weight of repository 10200 and/or receiver 10600, such as when dispenser 10000 is suspended from a distinct structure, such as a wheelchair. Chute 10400 can be formed from, e.g., a 1.5″ coupling 10420, 1.5″ 45 degree elbow 10480, and/or 1.5″ adapter 10490, which can have a threaded end portion and/or a corresponding nut 10495. The terminal and/or threaded end portion of adapter 10490 can protrude through an approximately 1.5″ hole in the side of a 4″ pipe cap (which can serve as a bowl and/or treat receiver 10600), and/or the corresponding nut can serve to secure the cap to the adapter, thereby coupling and/or attaching treat receiver 10600 to an outlet of chute 10400.

Located within coupling 10420 can be a valve 10900, such as a rotary valve, which can serve to selectively allow, control, throttle, disrupt, impede, and/or prevent flow of treats through chute 10400. A groove extending through coupling 10420 can allow a torque arm of valve 10900 to be moved, such that at least a portion of valve 10900 is correspondingly moved to a desired rotational position.

Shown in FIG. 11 is a rotary valve 11000 that can be utilized with any dispenser described herein. Rotary valve 11000 can comprise an upper portion 11200, which can be formed from, e.g., a 1.5″ PVC plug having a ground-off lip and/or end lettering, and/or having been cut to a desired length. Off-center in an otherwise substantially solid and/or closed end of such a plug can be a drilled hole or an orifice 11250 that has sized to allow dispenser contents, such as treats, to pass therethrough. Rotary valve 11000 can comprise a lower portion 11400, which can be formed from, e.g., a 1.5″ PVC plug having a ground-off lip and/or having been cut to a desired length. Off-center in an otherwise substantially solid and/or closed end of such a plug can be a drilled hole or an orifice 11450 that has sized to allow dispenser contents, such as treats, to pass therethrough. Attached and/or integral to upper portion 11200 and/or lower portion 11400 can be a torque-arm 11420, such as a handle, knob, lever, strap, screw, etc., that can be used to apply rotational force to the portion to which it is attached, thereby allowing relative rotational movement about a longitudinal axis of lower portion 11400 with respect to upper portion 11200. Such rotational capability of upper portion 11200 and/or lower portion 11400 can allow orifice 11250 to fully align with orifice 11450, such that dispenser contents can flow through both orifices. Such rotational capability can allow some degree of misalignment between orifice 11250 and orifice 11450, such that the flow of dispenser contents can be controlled, throttled, disrupted, impeded, and/or prevented. Although upper portion 11200 and lower portion 11400 are shown spaced apart in FIG. 11 to allow the features and/or elements of valve 11000 to be more easily described and/or understood, when valve 11000 is assembled in a dispenser, upper portion 11200 can be located adjacent to lower portion 11400.

Certain exemplary embodiments can utilize a treat dispenser comprising an auger, such as using any combination of components and/or techniques described herein, to remotely and/or non-manually deliver treats, such as within a vehicle, from a vehicle, from a bicycle, from a vehicle-mounted dispenser, from a bicycle-mounted dispenser, from a golf-cart-mounted dispenser, from a chair-mounted dispenser, from a wheelchair-mounted dispenser, from a bed-mounted dispenser, from a wall-mounted dispenser, from a free-standing dispenser, etc.

Via certain exemplary embodiments, the problem of timely dispensing between 1 and 6 treats to a service dog accompanying a person seated in a wheelchair while that wheelchair is in mobile operation, that person having substantially limited manual ability to dispense treats, can be solved by dispensing the treats to the dog on the person's demand, and/or on programmed demand, via a wheel-chair mounted, substantially jamming-resistant, switch-activated, open-core, auger-based machine.

Via certain exemplary embodiments, the problem of dispensing treats to a service dog accompanying a person seated in a wheelchair while that wheelchair is in mobile operation, that person having substantially limited manual ability to dispense treats, can be solved by, upon activation of a switch by the person, via a substantially jamming-resistant auger, automatically conveying the treats from a wheel-chair mounted repository to a receiver adapted to serve the treats to the dog.

Via certain exemplary embodiments, the problem of timely dispensing between 1 and 6 treats to a dog accompanying a walking person without requiring that person to touch the treats, can be solved by dispensing the treats to the dog on the person's demand, and/or on programmed demand, via a walking-stick enclosed, switch-activated, open-core, auger-based machine.

Via certain exemplary embodiments, the problem of timely and selectively dispensing between 1 and 6 treats to a dog accompanying a walking person without requiring that person to touch the treats, can be solved by dispensing the treats to the dog on the person's demand via a walking-stick enclosed, rotary valve-comprising device.

### DEFINITIONS

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
access—(n) a permission, liberty, right, mechanism, and/or ability to enter, approach, communicate with and/or through, make use of, take possession of, and/or pass to and/or from a place, thing, person, and/or animal; (v) to enter, approach, communicate with and/or through, make use of, and/or pass to and/or from
accompanying—to go and/or be with as a companion.
activate—to energize, make active, and/or set in motion.
activity—an action, act, step, and/or process or portion thereof
adapted—suitable, fit, and/or capable of performing a specified function.
adapted to—suitable, fit, and/or capable of performing a specified function.
adapter—a device used to effect operative compatibility between different parts of one or more pieces of an apparatus or system.
adjacent—close to; lying near; next to; adjoining, and/or within a horizontal radius of approximately 0.25 to approximately 4 inches of, including all values and subranges therebetween.
adjusted—to change and/or bring into a predetermined relationship.
allow—to provide, let do, happen, and/or permit.
along—over the length of and/or at various points on a length of
and/or—either in conjunction with or in alternative to.
angularly-adjustable—able to be moved such that an angle of the moved item changes with respect to a referencd point and/or item.
angularly-adjustably—configured to accommodate an adjustment to the angle of.
animal—an animal organism other than a human.
annunciator—a device that gives a visual indication and/or audible indication that announces which electrical circuit has become energized.
any—one, some, each, every, and/or all.
apparatus—an appliance and/or device adapted for a particular purpose.
associate—to join, connect together, and/or relate.
attach—to fasten, secure, couple, and/or join.
auger—a device adapted to be rotated to convey material, the device comprising at least one substantially helically-shaped flight portion.
automatic—performed via an information device in a manner essentially independent of influence and/or control by a user. For example, an automatic light switch can turn on upon “seeing” a person in its “view”, without the person manually operating the light switch.
battery—any of a class of devices that comprise one or more electrochemical cells that convert chemical energy into electrical energy.
between—intermediate to; and/or in and/or through a position and/or interval separating.
Boolean logic—a complete system for logical operations.
bowl—a substantially hemispherical vessel, typically wider than it is deep, that is often used for holding food and/or fluids.
bowl-like—substantially physically resembling a bowl.
can—is capable of, in at least some embodiments.
cause—to bring about, provoke, precipitate, produce, elicit, be the reason for, result in, and/or effect.
certain—some and/or particular.
circuit—a physical system comprising, depending on context: an electrically conductive pathway, an information transmission mechanism, and/or a communications connection, the pathway, mechanism, and/or connection established via a switching device (such as a switch, relay, transistor, and/or logic gate, etc.); and/or an electrically conductive pathway, an information transmission mechanism, and/or a communications connection, the pathway, mechanism, and/or connection established across two or more switching devices comprised by a network and between corresponding end systems connected to, but not comprised by the network.
coaxial—having and/or mounted on a common axis.
coil—(n) a continuous loop comprising two or more turns of electrically conductive material. (v) to roll and/or form into a configuration having a substantially spiraled cross-section.
comprises—includes, but is not limited to, what follows.
comprising—including but not limited to, what follows.
configure—to make suitable or fit for a specific use or situation.
connect—to join or fasten together.
containing—including but not limited to.
convert—to transform, adapt, and/or change.
convey—to transmit, transport, guide, and/or carry.
core—a central and/or innermost part, particularly of a cylindrical object.
correspond—to be in agreement, harmony, or conformity.
couplable—capable of being joined, connected, and/or linked together.
couple—to connect and/or link via any known way, including mechanical, fluidic, acoustic, electrical, magnetic, and/or optical, etc.
couple—to join, link, and/or connect.
coupleable—capable of being joined, linked, and/or connected.
coupling—linking in some fashion.
cover—to overlay, place upon and/or over, and/or immerse.
create—to bring into being.
current—a flow of electrical energy.
data—distinct pieces of information, usually formatted in a special or predetermined way and/or organized to express concepts, and/or represented in a form suitable for processing by an information device.
data structure—an organization of a collection of data that allows the data to be manipulated effectively and/or a logical relationship among data elements that is designed to support specific data manipulation functions. A data structure can comprise meta data to describe the properties of the data structure. Examples of data structures can include: array, dictionary, graph, hash, heap, linked list, matrix, object, queue, ring, stack, tree, and/or vector.
define—to establish the meaning, relationship, outline, form, and/or structure of; and/or to precisely and/or distinctly describe and/or specify.
demand—to request, order, and/or command, such as verbally, in writing, and/or via an action such as actuating a switch.
determine—to find out, obtain, calculate, decide, deduce, ascertain, and/or come to a decision, typically by investigation, reasoning, and/or calculation.
device—a machine, manufacture, and/or collection thereof.
diameter—a length of a straight line segment passing through a center of an object and terminating at the periphery thereof.
digital—non-analog and/or discrete.
direct current—a non-alternating electric current.
disassemble—to dismantle, come apart, take apart.
dispense—to provide, distribute, and/or deal out, sometimes in parts and/or portions.
electrically—of, relating to, producing, or operated by electricity.
electrically coupled—connected in a manner adapted to allow a flow of electricity therebetween.
element—a component.
embodiment—an implementation and/or physical manifestation.
enclose—to substantially surround on all sides, shelter, envelop, contain, and/or close in.
enclosed—surrounded on all sides.
estimate—(n) a calculated value approximating an actual value; (v) to calculate and/or determine approximately and/or tentatively.
exemplary—serving as a model and/or example.
feed—to convey, supply, move, channel, and/or transfer.
fit—to not exceed the dimensions of and/or to not extend beyond the boundaries of
flexible—capable of substantial bending and/or flexing without breaking
flow path—a route along which a fluid and/or solids can be conveyed.
fluid—a liquid, slurry, vapor, mist, cloud, plume, and/or foam, etc.
fluidly—of, concerned with, using, and/or conveying a fluid and/or fluids.
from—used to indicate a source.
further—in addition.
gear—a machine element used to transmit motion between rotating shafts.
gearhead—a set of gears adapted to be mounted in very close proximity to the output shaft of a motor, and to be located within an enclosure that encloses the motor or attaches directly to an enclosure of the motor.
generally—for the most part and/or substantially.
generate—to create, produce, give rise to, and/or bring into existence.
gravitation—the natural phenomenon of attraction between physical objects with mass and/or the act and/or process of moving under the influence of this attraction.
guide—to direct, steer, and/or exert control and/or influence over.
haptic—involving the human sense of kinesthetic movement and/or the human sense of touch. Among the many potential haptic experiences are numerous sensations, body-positional differences in sensations, and time-based changes in sensations that are perceived at least partially in non-visual, non-audible, and non-olfactory manners, including the experiences of tactile touch (being touched), active touch, grasping, pressure, friction, traction, slip, stretch, force, torque, impact, puncture, vibration, motion, acceleration, jerk, pulse, orientation, limb position, gravity, texture, gap, recess, viscosity, pain, itch, moisture, temperature, thermal conductivity, and thermal capacity.
having—including but not limited to.
helical spring—a wound (typically metallic) flexible elastic coil, having the shape of a helix, that regains its original shape after being compressed or extended, and that can be used to store mechanical energy.
hollow—having a cavity, gap, and/or space within.
housing—something that covers, encloses, protects, holds, and/or supports, such as a frame, box, and/or chassis.
human-machine interface—hardware and/or software adapted to render information to a user and/or receive information from the user; and/or a user interface.
human-selected—substantially contemporaneously selected by a human.
impede—to retard, restrict, and/or obstruct in action and/or progress.
including—including but not limited to.
information device—any device capable of processing data and/or information, such as any general purpose and/or special purpose computer, such as a personal computer, workstation, server, minicomputer, mainframe, supercomputer, computer terminal, laptop, tablet computer (such as an iPad-like device), wearable computer, Personal Digital Assistant (PDA), mobile terminal, Bluetooth device, communicator, “smart” phone (such as an iPhone-like device), messaging service (e.g., Blackberry) receiver, pager, facsimile, cellular telephone, traditional telephone, telephonic device, embedded controller, programmed microprocessor or microcontroller and/or peripheral integrated circuit elements, ASIC or other integrated circuit, hardware electronic logic circuit such as a discrete element circuit, and/or programmable logic device such as a PLD, PLA, FPGA, or PAL, or the like, etc. In general, any device on which resides a finite state machine capable of implementing at least a portion of a method, structure, and/or or graphical user interface described herein may be used as an information device. An information device can comprise components such as one or more network interfaces, one or more processors, one or more memories containing instructions, and/or one or more input/output (I/O) devices, one or more user interfaces coupled to an I/O device, etc. In information device can be a component of and/or augment another device, such as an appliance, machine, tool, robot, vehicle, television, printer, “smart” utility meter, etc.
ingestion—the process of eating.
initialize—to prepare something for use and/or some future event.
input/output (I/O) device—any device adapted to provide input to, and/or receive output from, an information device. Examples can include an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, switch, relay, haptic device, vibrator, tactile simulator, and/or tactile pad, potentially including a port to which an I/O device can be attached or connected.
install—to connect or set in position and prepare for use.
instructions—directions, which can be implemented as hardware, firmware, and/or software, the directions adapted to perform a particular operation and/or function via creation and/or maintenance of a predetermined physical circuit.
kibble—a foodstuff that is animal-edible, relatively small, substantially dry, substantially hard, substantially brittle, processed, manufactured, coarsely ground, meal-based, cereal-based, and/or grain-based, etc.
like—possessing the characteristics of; resembling closely; and/or similar to.
location—a position and/or place.
logic gate—a physical device adapted to perform a logical operation on one or more logic inputs and to produce a single logic output, which is manifested physically. Because the output is also a logic-level value, an output of one logic gate can connect to the input of one or more other logic gates, and via such combinations, complex operations can be performed. The logic normally performed is Boolean logic and is most commonly found in digital circuits. The most common implementations of logic gates are based on electronics using resistors, transistors, and/or diodes, and such implementations often appear in large arrays in the form of integrated circuits (a.k.a., IC's, microcircuits, microchips, silicon chips, and/or chips). It is possible, however, to create logic gates that operate based on vacuum tubes, electromagnetics (e.g., relays), mechanics (e.g., gears), fluidics, optics, chemical reactions, and/or DNA, including on a molecular scale. Each electronically-implemented logic gate typically has two inputs and one output, each having a logic level or state typically physically represented by a voltage. At any given moment, every terminal is in one of the two binary logic states (“false” (a.k.a., “low” or “0”) or “true” (a.k.a., “high” or “1”), represented by different voltage levels, yet the logic state of a terminal can, and generally does, change often, as the circuit processes data. Thus, each electronic logic gate typically requires power so that it can source and/or sink currents to achieve the correct output voltage. Typically, machine-implementable instructions are ultimately encoded into binary values of “0”s and/or “1”s and, are typically written into and/or onto a memory device, such as a “register”, which records the binary value as a change in a physical property of the memory device, such as a change in voltage, current, charge, phase, pressure, weight, height, tension, level, gap, position, velocity, momentum, force, temperature, polarity, magnetic field, magnetic force, magnetic orientation, reflectivity, molecular linkage, molecular weight, etc. An exemplary register might store a value of “01101100”, which encodes a total of 8 “bits” (one byte), where each value of either “0” or “1” is called a “bit” (and 8 bits are collectively called a “byte”). Note that because a binary bit can only have one of two different values (either “0” or “1”), any physical medium capable of switching between two saturated states can be used to represent a bit. Therefore, any physical system capable of representing binary bits is able to represent numerical quantities, and potentially can manipulate those numbers via particular encoded machine-implementable instructions. This is one of the basic concepts underlying digital computing. At the register and/or gate level, a computer does not treat these “0”s and “1”s as numbers per se, but typically as voltage levels (in the case of an electronically-implemented computer), for example, a high voltage of approximately +3 volts might represent a “1” or “logical true” and a low voltage of approximately 0 volts might represent a “0” or “logical false” (or vice versa, depending on how the circuitry is designed). These high and low voltages (or other physical properties, depending on the nature of the implementation) are typically fed into a series of logic gates, which in turn, through the correct logic design, produce the physical and logical results specified by the particular encoded machine-implementable instructions. For example, if the encoding request a calculation, the logic gates might add the first two bits of the encoding together, produce a result “1” (“0”+“1”=“1”), and then write this result into another register for subsequent retrieval and reading. Or, if the encoding is a request for some kind of service, the logic gates might in turn access or write into some other registers which would in turn trigger other logic gates to initiate the requested service.
logical—a conceptual representation.
longitudinal axis—a straight line defined parallel to an object's length and passing through a centroid of the object.
machine-implementable instructions—directions adapted to cause a machine, such as an information device, to perform one or more particular activities, operations, and/or functions via forming a particular physical circuit. The directions, which can sometimes form an entity called a “processor”, “kernel”, “operating system”, “program”, “application”, “utility”, “subroutine”, “script”, “macro”, “file”, “project”, “module”, “library”, “class”, and/or “object”, etc., can be embodied and/or encoded as machine code, source code, object code, compiled code, assembled code, interpretable code, and/or executable code, etc., in hardware, firmware, and/or software.
machine-readable medium—a physical structure from which a machine, such as an information device, computer, microprocessor, and/or controller, etc., can store and/or obtain one or more machine-implementable instructions, data, and/or information. Examples include a memory device, punch card, player-piano scroll, etc.
malleable—capable of being shaped and/or formed
mammal—Any of various warm-blooded vertebrate animals of the class Mammalia, excluding humans, characterized by a covering of hair on the skin and, in the female, milk-producing mammary glands for nourishing the young.
manual—done with one or more adult human hands having normal performance capabilities.
may—is allowed and/or permitted to, in at least some embodiments.
mechanically coupled—at least a first object and a second object joined, connected, and/or linked so as to allow the second object to physically move in response to a physical movement of the first object.
memory device—an apparatus capable of storing, sometimes permanently, machine-implementable instructions, data, and/or information, in analog and/or digital format. Examples include at least one non-volatile memory, volatile memory, register, relay, switch, Random Access Memory, RAM, Read Only Memory, ROM, flash memory, magnetic media, hard disk, floppy disk, magnetic tape, optical media, optical disk, compact disk, CD, digital versatile disk, DVD, and/or raid array, etc. The memory device can be coupled to a processor and/or can store and provide instructions adapted to be executed by processor, such as according to an embodiment disclosed herein.
method—one or more acts that are performed upon subject matter to be transformed to a different state or thing and/or are tied to a particular apparatus, said one or more acts not a fundamental principal and not pre-empting all uses of a fundamental principal.
mobile operation—moving pursuant to human power and/or demand.
motor—a device that converts electrical energy into mechanical energy to turn a shaft.
mount—(n) that upon which a thing is attached. (v) to couple, fix, and/or attach on and/or to something.
network—a communicatively coupled plurality of nodes, communication devices, and/or information devices. Via a network, such nodes and/or devices can be linked, such as via various wireline and/or wireless media, such as cables, telephone lines, power lines, optical fibers, radio waves, and/or light beams, etc., to share resources (such as printers and/or memory devices), exchange files, and/or allow electronic communications therebetween. A network can be and/or can utilize any of a wide variety of sub-networks and/or protocols, such as a circuit switched, public-switched, packet switched, connection-less, wireless, virtual, radio, data, telephone, twisted pair, POTS, non-POTS, DSL, cellular, telecommunications, video distribution, cable, radio, terrestrial, microwave, broadcast, satellite, broadband, corporate, global, national, regional, wide area, backbone, packet-switched TCP/IP, IEEE 802.03, Ethernet, Fast Ethernet, Token Ring, local area, wide area, IP, public Internet, intranet, private, ATM, Ultra Wide Band (UWB), Wi-Fi, BlueTooth, Airport, IEEE 802.11, IEEE 802.11a, IEEE 802.11b, IEEE 802.11g, X-10, electrical power, 3G, 4G, multi-domain, and/or multi-zone sub-network and/or protocol, one or more Internet service providers, one or more network interfaces, and/or one or more information devices, such as a switch, router, and/or gateway not directly connected to a local area network, etc., and/or any equivalents thereof.
network interface—any physical and/or logical device, system, and/or process capable of coupling an information device to a network. Exemplary network interfaces comprise a telephone, cellular phone, cellular modem, telephone data modem, fax modem, wireless transceiver, communications port, ethernet card, cable modem, digital subscriber line interface, bridge, hub, router, or other similar device, software to manage such a device, and/or software to provide a function of such a device.
non-destructively—of, relating to, or being an activity and/or collection of activities that does not result in damage to the subject material and/or product and/or results in such minimal damage that the subject material and/or product can be re-used for its intended purpose.
occupant—one who occupies and/or is found within.
open—affording substantially unobstructed entrance and exit; and/or not shut or closed.
operation—the act and/or process of operating and/or functioning.
operative—being in effect; operating.
outlet—an exit.
packet—a generic term for a bundle of data organized in a specific way for transmission, such as within and/or across a network, such as a digital packet-switching network, and comprising the data to be transmitted and certain control information, such as a destination address.
pair—a quantity of two of something.
parallel—of, relating to, or designating lines, curves, planes, and/or or surfaces everywhere equidistant and/or an arrangement of components in an electrical circuit that splits an electrical current into two or more paths.
perceptible—capable of being perceived by the human senses.
person—a human.
physical—tangible, real, and/or actual.
physically—existing, happening, occurring, acting, and/or operating in a manner that is tangible, real, and/or actual.
physically disabled—a person having one or more diminished and/or absent physical abilities in comparison to those of a statistically normal person of similar age.
pitch—with regard to an auger, a measure of the spacing between a predetermined local maximum diameter and an adjacent and parallel local maximum diameter of the auger.
plurality—the state of being plural and/or more than one.
polymer—any of numerous natural and synthetic compounds of usually high molecular weight consisting of up to millions of repeated linked units, each a relatively light and simple molecule.
polymer-covered—substantially enclosed by a polymeric material.
portion—a part, component, section, percentage, ratio, and/or quantity that is less than a larger whole and that can be visually, physically, and/or virtually distinguishable.
positionally-adjustably—configured to accommodate an adjustment to the physical position of.
power supply—one or more electrically coupled components configured to provide electrical energy to a device and/or system.
predetermine—to determine, decide, and/or establish in advance.
probability—a quantitative representation of a likelihood of an occurrence.
processor—a machine that utilizes hardware, firmware, and/or software and is physically adaptable to perform, via Boolean logic operating on a plurality of logic gates that form particular physical circuits, a specific task defined by a set of machine-implementable instructions. A processor can utilize mechanical, pneumatic, hydraulic, electrical, magnetic, optical, informational, chemical, and/or biological principles, mechanisms, adaptations, signals, inputs, and/or outputs to perform the task(s). In certain embodiments, a processor can act upon information by manipulating, analyzing, modifying, and/or converting it, transmitting the information for use by machine-implementable instructions and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium family of microprocessor manufactured by the Intel Corporation of Santa Clara, Calif. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein. A processor can reside on and use the capabilities of a controller.
profile—a representation, outline, and/or description of an object, structure, and/or surface.
protect—to attempt to prevent and/or avoid damage.
provide—to furnish, supply, give, convey, send, and/or make available.
receive—to gather, take, acquire, obtain, accept, get, and/or have bestowed upon.
receiver—a destination of, and/or receptacle for, a conveyed item and/or signal.
recommend—to suggest, praise, commend, and/or endorse.
render—to, e.g., physically, chemically, biologically, electronically, electrically, magnetically, optically, acoustically, fluidically, and/or mechanically, etc., transform information into a form perceptible to a human as, for example, data, commands, text, graphics, audio, video, animation, and/or hyperlinks, etc., such as via a visual, audio, and/or haptic, etc., means and/or depiction, such as via a display, monitor, electric paper, ocular implant, cochlear implant, speaker, vibrator, shaker, force-feedback device, stylus, joystick, steering wheel, glove, blower, heater, cooler, pin array, tactile touchscreen, etc.
repeatedly—again and again; repetitively.
repository—a device in which objects can be stored.
request—to express a desire for and/or ask for.
rotatable—capable of rotation.
said—when used in a system or device claim, an article indicating a subsequent claim term that has been previously introduced.
select—to make a choice or selection from alternatives.
selected—a chosen item.
server—an information device and/or a process running thereon, that is adapted to be communicatively coupled to a network and that is adapted to provide at least one service for at least one client, i.e., for at least one other information device communicatively coupled to the network and/or for at least one process running on another information device communicatively coupled to the network. One example is a file server, which has a local drive and services requests from remote clients to read, write, and/or manage files on that drive. Another example is an e-mail server, which provides at least one program that accepts, temporarily stores, relays, and/or delivers e-mail messages. Still another example is a database server, which processes database queries. Yet another example is a device server, which provides networked and/or programmable: access to, and/or monitoring, management, and/or control of, shared physical resources and/or devices, such as information devices, printers, modems, scanners, projectors, displays, lights, cameras, security equipment, proximity readers, card readers, kiosks, POS/retail equipment, phone systems, residential equipment, HVAC equipment, medical equipment, laboratory equipment, industrial equipment, machine tools, pumps, fans, motor drives, scales, programmable logic controllers, sensors, data collectors, actuators, alarms, annunciators, and/or input/output devices, etc.
set—a related plurality.
signal—(v) to communicate; (n) automatically detectable variations in a physical variable, such as a pneumatic, hydraulic, acoustic, fluidic, mechanical, electrical, magnetic, optical, chemical, and/or biological variable, such as power, energy, pressure, flowrate, viscosity, density, torque, impact, force, frequency, phase, voltage, current, resistance, magnetomotive force, magnetic field intensity, magnetic field flux, magnetic flux density, reluctance, permeability, index of refraction, optical wavelength, polarization, reflectance, transmittance, phase shift, concentration, and/or temperature, etc., that encode information, such as machine-implementable instructions for activities and/or one or more letters, words, characters, symbols, signal flags, visual displays, and/or special sounds, etc., having prearranged meaning Depending on the context, a signal and/or the information encoded therein can be synchronous, asynchronous, hard real-time, soft real-time, non-real time, continuously generated, continuously varying, analog, discretely generated, discretely varying, quantized, digital, broadcast, multicast, unicast, transmitted, conveyed, received, continuously measured, discretely measured, processed, encoded, encrypted, multiplexed, modulated, spread, de-spread, demodulated, detected, de-multiplexed, decrypted, and/or decoded, etc.
signal—(v) to communicate; (n) one or more automatically detectable variations in a physical variable, such as a pneumatic, hydraulic, acoustic, fluidic, mechanical, electrical, magnetic, optical, chemical, and/or biological variable, such as power, energy, pressure, flowrate, viscosity, density, torque, impact, force, frequency, phase, voltage, current, resistance, magnetomotive force, magnetic field intensity, magnetic field flux, magnetic flux density, reluctance, permeability, index of refraction, optical wavelength, polarization, reflectance, transmittance, phase shift, concentration, and/or temperature, etc., that can encode information, such as machine-implementable instructions for activities and/or one or more letters, words, characters, symbols, signal flags, visual displays, and/or special sounds, etc., having prearranged meaning Depending on the context, a signal and/or the information encoded therein can be synchronous, asynchronous, hard real-time, soft real-time, non-real time, continuously generated, continuously varying, analog, discretely generated, discretely varying, quantized, digital, broadcast, multicast, unicast, transmitted, conveyed, received, continuously measured, discretely measured, processed, encoded, encrypted, multiplexed, modulated, spread, de-spread, demodulated, detected, de-multiplexed, decrypted, and/or decoded, etc.
space—a gap.
spatially-adjustable—able to be moved to a plurality of locations within a predetermined volume.
spatially-adjustably—configured to accommodate an adjustment to the spatial position of.
special purpose computer—a computer and/or information device comprising a processor device having a plurality of logic gates, whereby at least a portion of those logic gates, via implementation of specific machine-implementable instructions by the processor, experience a change in at least one physical and measurable property, such as a voltage, current, charge, phase, pressure, weight, height, tension, level, gap, position, velocity, momentum, force, temperature, polarity, magnetic field, magnetic force, magnetic orientation, reflectivity, molecular linkage, molecular weight, etc., thereby directly tying the specific machine-implementable instructions to the logic gate's specific configuration and property(ies). In the context of an electronic computer, each such change in the logic gates creates a specific electrical circuit, thereby directly tying the specific machine-implementable instructions to that specific electrical circuit.
special purpose processor—a processor device, having a plurality of logic gates, whereby at least a portion of those logic gates, via implementation of specific machine-implementable instructions by the processor, experience a change in at least one physical and measurable property, such as a voltage, current, charge, phase, pressure, weight, height, tension, level, gap, position, velocity, momentum, force, temperature, polarity, magnetic field, magnetic force, magnetic orientation, reflectivity, molecular linkage, molecular weight, etc., thereby directly tying the specific machine-implementable instructions to the logic gate's specific configuration and property(ies). In the context of an electronic computer, each such change in the logic gates creates a specific electrical circuit, thereby directly tying the specific machine-implementable instructions to that specific electrical circuit.
store—to place, hold, and/or retain.
substantially—to a considerable, large, and/or great, but not necessarily whole and/or entire, extent and/or degree.
support—to bear the weight of and/or hold in position so as to keep from falling.
support—to bear the weight of, especially from below.
surround—to encircle, enclose, and/or confine on several and/or all sides.
switch—(v) to: form, open, and/or close one or more circuits; form, complete, and/or break an electrical and/or informational path; select a path and/or circuit from a plurality of available paths and/or circuits; and/or establish a connection between disparate transmission path segments in a network (or between networks); (n) a physical device, such as a mechanical, electrical, and/or electronic device, that is adapted to switch.
switch-activation ability—an ability of a human to activate a predetermined switch.
system—a collection of mechanisms, devices, machines, articles of manufacture, processes, data, and/or instructions, the collection designed to perform one or more specific functions.
transform—to change in measurable: form, appearance, nature, and/or character.
transmit—to send as a signal, provide, furnish, and/or supply.
treat—(v.) to reward an animal that demonstrates a desired behavior; (n) a reward for an animal that demonstrates a desired behavior. Examples of treats (n.) can include kibble; foodstuffs, such as those that are natural, fresh, raw, live, unprocessed, substantially oily, and/or substantially wet, etc.; and/or objects that roll, bounce, move, rattle, squeak, shine, and/or glitter, etc.
tubular—of, relating to, and/or resembling a tube and/or shaped substantially like a tube.
type—a number of things having in common traits or characteristics that distinguish them as a group or class.
user interface—any device for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.
vary—to deviate and/or show change.
vertical—substantially perpendicular to horizontal.
via—by way of and/or utilizing.
walking stick—a cane or staff used by a human as an aid in walking
wheelchair—a chair mounted on wheels for the use of a sick or disabled person.
wherein—in regard to which; and; and/or in addition to.
within—inside.

### Note

Various substantially and specifically practical and useful exemplary embodiments of the claimed subject matter are described herein, textually and/or graphically, including the best mode, if any, known to the inventor(s), for implementing the claimed subject matter by persons having ordinary skill in the art. Any of numerous possible variations (e.g., modifications, augmentations, embellishments, refinements, and/or enhancements, etc.), details (e.g., species, aspects, nuances, and/or elaborations, etc.), and/or equivalents (e.g., substitutions, replacements, combinations, and/or alternatives, etc.) of one or more embodiments described herein might become apparent upon reading this document to a person having ordinary skill in the art, relying upon his/her expertise and/or knowledge of the entirety of the art and without exercising undue experimentation. The inventor(s) expects skilled artisans to implement such variations, details, and/or equivalents as appropriate, and the inventor(s) therefore intends for the claimed subject matter to be practiced other than as specifically described herein. Accordingly, as permitted by law, the claimed subject matter includes and covers all variations, details, and equivalents of that claimed subject matter. Moreover, as permitted by law, every combination of the herein described characteristics, functions, activities, substances, and/or structural elements, and all possible variations, details, and equivalents thereof, is encompassed by the claimed subject matter unless otherwise clearly indicated herein, clearly and specifically disclaimed, or otherwise clearly contradicted by context.

The use of any and all examples, or exemplary language (e.g., “such as”) provided herein, is intended merely to better illuminate one or more embodiments and does not pose a limitation on the scope of any claimed subject matter unless otherwise stated. No language herein should be construed as indicating any non-claimed subject matter as essential to the practice of the claimed subject matter.

Thus, regardless of the content of any portion (e.g., title, field, background, summary, description, abstract, drawing figure, etc.) of this document, unless clearly specified to the contrary, such as via explicit definition, assertion, or argument, or clearly contradicted by context, with respect to any claim, whether of this document and/or any claim of any document claiming priority hereto, and whether originally presented or otherwise:
there is no requirement for the inclusion of any particular described characteristic, function, activity, substance, or structural element, for any particular sequence of activities, for any particular combination of substances, or for any particular interrelationship of elements;
no described characteristic, function, activity, substance, or structural element is “essential”;
any two or more described substances can be mixed, combined, reacted, separated, and/or segregated;
any described characteristics, functions, activities, substances, and/or structural elements can be integrated, segregated, and/or duplicated;
any described activity can be performed manually, semi-automatically, and/or automatically;
any described activity can be repeated, any activity can be performed by multiple entities, and/or any activity can be performed in multiple jurisdictions; and
any described characteristic, function, activity, substance, and/or structural element can be specifically excluded, the sequence of activities can vary, and/or the interrelationship of structural elements can vary.
The use of the terms “a”, “an”, “said”, “the”, and/or similar referents in the context of describing various embodiments (especially in the context of the following claims) are to be construed to cover both the singular and the plural, unless otherwise indicated herein or clearly contradicted by context.

The terms “comprising,” “having,” “including,” and “containing” are to be construed as open-ended terms (i.e., meaning “including, but not limited to,”) unless otherwise noted.

When any number or range is described herein, unless clearly stated otherwise, that number or range is approximate. Recitation of ranges of values herein are merely intended to serve as a shorthand method of referring individually to each separate value falling within the range, unless otherwise indicated herein, and each separate value and each separate subrange defined by such separate values is incorporated into the specification as if it were individually recited herein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any phrase (i.e., one or more words) appearing in a claim is followed by a drawing element number, that drawing element number is exemplary and non-limiting on claim scope.

No claim of this document is intended to invoke paragraph six of 35 USC 112 unless the precise phrase “means for” is followed by a gerund.

Any information in any material (e.g., a United States patent, United States patent application, book, article, etc.) that has been incorporated by reference herein, is incorporated by reference herein in its entirety to its fullest enabling extent permitted by law yet only to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Within this document, and during prosecution of any patent application related hereto, any reference to any claimed subject matter is intended to reference the precise language of the then-pending claimed subject matter at that particular point in time only.

Accordingly, every portion (e.g., title, field, background, summary, description, abstract, drawing figure, etc.) of this document, other than the claims themselves and any provided definitions of the phrases used therein, is to be regarded as illustrative in nature, and not as restrictive. The scope of subject matter protected by any claim of any patent that issues based on this document is defined and limited only by the precise language of that claim (and all legal equivalents thereof) and any provided definition of any phrase used in that claim, as informed by the context of this document.

What is claimed is:

1. An apparatus comprising:
a helical spring-type auger that:
is operatively adapted to convey a human-selected portion of a plurality of treats;
defines an open core;
is manually malleable;
is substantially polymer-covered;
comprises a manually malleable first coil; and
comprises a substantially polymer-covered manually malleable second coil that is substantially parallel to said first coil;
a direct current motor that is:
operatively mechanically coupled to said auger; and
operatively electrically couplable to a direct current power supply;
a treat repository operatively adapted to:
protect a stored portion of the plurality of treats from access by an animal; and
supply the human-selected portion of the plurality of treats to said auger;
an annunciator that is:
operatively electrically activateable by said direct current power supply; and
operatively adapted to signal operation of said auger to the animal; and
a housing operatively adapted to:
substantially surround said auger and said motor;
guide the human-selected portion of the plurality of treats from said treat repository to an outlet of said housing;
mechanically attach to a wheelchair; and
substantially fit within a vertical profile of said wheelchair;
said housing comprising a plurality of elements that are:
generally tubular;
substantially hollow;
rotatably connected; and
non-destructively disassemblable;
said apparatus operatively adapted to mount to the wheelchair and to dispense the human-selected portion of the plurality of treats to the animal upon demand of a human occupant of the wheelchair while the wheelchair is in mobile operation.

2. An apparatus comprising:
a flexible helical auger that:
is operatively adapted to convey a human-selected portion of a plurality of treats;
defines an open core;
is manually malleable;
comprises a polymer portion;
comprises a manually malleable first coil; and
comprises a substantially polymer-covered manually malleable second coil that is substantially parallel to said first coil;
a direct current motor that is:
operatively mechanically couplable to said auger; and
operatively electrically couplable to a direct current power supply; and
a housing operatively adapted to:
substantially surround said auger and said motor; and
guide the human-selected portion of the plurality of treats from a treat repository to an outlet of said housing;
said housing comprising a plurality of portions that are:
generally tubular; and
substantially hollow.

3. The apparatus of claim 2, wherein said auger defines a longitudinal axis and a diameter of said auger varies along said longitudinal axis.

4. The apparatus of claim 2, wherein said auger defines a longitudinal axis and a diameter of said auger is adapted to be manually adjusted at predetermined locations along said longitudinal axis.

5. The apparatus of claim 2, wherein said auger defines a longitudinal axis and a pitch of said auger varies along said longitudinal axis.

6. The apparatus of claim 2, wherein said auger defines a longitudinal axis and a pitch of said auger is adapted to be manually adjusted along said longitudinal axis.

7. The apparatus of claim 2, further comprising a treat repository that is operatively adapted to gravitationally feed the plurality of treats to said auger and to protect a stored portion of the plurality of treats from access by an animal.

8. The apparatus of claim 2, where said plurality of portions of said housing are rotatably connected.

9. The apparatus of claim 2, where said plurality of portions of said housing are non-destructively disassemblable.

10. The apparatus of claim 2, wherein said housing is operatively adapted to provide a substantially enclosed flow path for the human-selected portion of the plurality of treats between the treat repository and a treat receiver that is adapted to provide an animal with access to the human-selected portion of the plurality of treats.

11. The apparatus of claim 2, where said housing is operatively adapted to:
mechanically attach to a wheelchair;
be supported by the wheelchair; and
substantially fit within a vertical profile of the wheelchair.

12. The apparatus of claim 2, further comprising:
a direct current power supply substantially enclosed within said housing.

13. The apparatus of claim 2, further comprising a treat receiver that is:
positionally-adjustably connected to said housing;
mechanically supported by said housing;
adapted to receive the human-selected portion of the plurality of treats from said housing; and
adapted to make the human-selected portion of the plurality of treats accessible to an animal for ingestion.

14. The apparatus of claim 2, further comprising a treat receiver that is:
bowl-like;
fluidly connected to said housing;
rotatably connected to said housing;
spatially-adjustably connected to said housing;
angularly-adjustably connected to said housing;
mechanically supported by said housing;
adapted to receive the human-selected portion of the plurality of treats from said housing; and/or
adapted to make the human-selected portion of the plurality of treats accessible to an animal.

15. The apparatus of claim 2, wherein:
said apparatus is operatively adapted to mount to a wheelchair and to dispense the treats to an animal upon demand of a human occupant of the wheelchair while the wheelchair is in mobile operation.

16. The apparatus of claim 2, wherein said motor is a gearhead motor.

17. The apparatus of claim 2, further comprising:
an annunciator that is operatively adapted to signal operation of said auger to an animal accompanying said apparatus.

18. The apparatus of claim 2, further comprising a switch electrically coupled to said direct current power supply and said motor, said switch selected to correspond to a switch-activation ability of a predetermined physically disabled person.

19. A walking stick comprising:
a helical auger that:
is operatively adapted to convey a human-selected portion of a plurality of treats;
defines an open core;
is manually malleable;
is substantially polymer-covered;
comprises a manually malleable first coil; and
comprises a substantially polymer-covered manually malleable second coil that is substantially parallel to said first coil;
a direct current motor that is:
operatively mechanically coupled to said auger; and
operatively electrically couplable to a direct current power supply;
a housing operatively adapted to:
substantially surround said auger and said motor;
protect a stored portion of the plurality of treats from access by an animal; and
guide the human-selected portion of the plurality of treats to an outlet of said housing;
said housing comprising a plurality of elements that are:
generally tubular; and
substantially hollow;
said walking stick operatively adapted to dispense the human-selected portion of the plurality of treats to the animal while said walking stick is in mobile operation.

20. The apparatus of claim 19, further comprising a treat receiver that is:
mechanically supported by said housing;
adapted to receive the human-selected portion of the treats from said housing; and
adapted to make the human-selected portion of the treats accessible to the animal for ingestion.
